(19) United States
(12) Patent Application Publication
(10) Pub. No.: US 2012/0000204 A1
(43) Pub. Date: Jan. 5, 2012

(54) MULTI-SPOOL INTERCOOLED RECUPERATED GAS TURBINE

(75) Inventors: James B. Kesseli, Greenland, NH (US); James S. Nash, North Hampton, NH (US); John D. Watson, Evergreen, CO (US); Thomas L. Wolf, Winchester, MA (US)

(73) Assignee: ICR TURBINE ENGINE CORPORATION, Hampton, NH (US)

(21) Appl. No.: 13/175,564

(22) Filed: Jul. 1, 2011

Related U.S. Application Data
(60) Provisional application No. 61/361,083, filed on Jul. 2, 2010.

(51) Int. Cl. F02C 7/26; F02C 6/00; F02C 6/14; F02C 3/107

(52) U.S. Cl. 60/778; 60/792; 60/786; 60/801; 60/772

(57) ABSTRACT

A method and apparatus are disclosed for a multi-spool gas turbine power plant which utilizes motor/generator devices on two or more spools for starting the gas turbine and for power extraction after starting. Methods are disclosed for controlling engine responsiveness under changing load and/or ambient air conditions; providing a momentary power boost when required; providing some engine braking when needed; providing over-speed protection for the free power turbine when load is rapidly lowered or disconnected; charging an energy storage system; and restoring the compressors and/or turbines toward their operating lines when surge or choking limits are approached.

### CROSS REFERENCE TO RELATED APPLICATION

The present application claims the benefits, under 35 U.S.C.§119(e), of U.S. Provisional Application Serial No. 61/361,083 entitled “Improved Multi-Spool Intercooled Recuperated Gas Turbine” filed on Jul. 2, 2010, which is incorporated herein by reference.

### FIELD

The present invention relates generally to gas turbine engines and in particular to methods of starting a multi-spool gas turbine engine and controlling engine performance and responsiveness.

### BACKGROUND

There is a growing requirement for alternate fuels for vehicle propulsion and power generation. These include fuels such as natural gas, bio-diesel, ethanol, butanol, hydrogen and the like. Means of utilizing fuels needs to be accomplished more efficiently and with substantially lower carbon dioxide emissions and other air pollutants such as NOxs.

The gas turbine or Brayton cycle power plant has demonstrated many attractive features which make it a candidate for advanced vehicular propulsion as well as power generation. Gas turbine engines have the advantage of being highly fuel flexible and fuel tolerant. Additionally, these engines burn fuel at a lower temperature than comparable reciprocating engines so produce substantially less NOx per mass of fuel burned.

A multi-spool intercooled, recuperated gas turbine system is particularly suited for use as a power plant for a vehicle, especially a truck, bus or other overland vehicle. However, it has broader applications and may be used in many different environments and applications, including as a stationary electric power module for distributed power generation.

Vehicular applications, such as large trucks and buses, demand a very wide power range of operation. The multi-spool configurations described herein create opportunities to improve engine start-up, to improve engine responsiveness and to control the engine to over a broad output power range.

A conventional gas turbine may be composed of two or more turbo compressor rotating assemblies to achieve progressively higher pressure ratio. A prior art turbo machine composed of three independent rotating assemblies or “spools,” including a high pressure turbo compressor spool, a low pressure turbo compressor spool and a free turbine spool is described in U.S. patent application Ser. No. 12/115,134 entitled “Multi-Spool Intercooled Recuperated Gas Turbine”. Both the high and low pressure spools are composed of a compressor, a turbine, and a shaft connecting the two. The free turbine spool is composed of a turbine, a load device, and a shaft connecting the two. The load device is normally a generator power generation or a transmission for a vehicular application. A combustor is used to heat the air between the recuperator and high pressure turbine.

A common method for starting a turbo machine is to provide an electro-mechanical motive power to the high pressure spool. A motor/clutch is engaged to provide rotary power to the high pressure spool. Once the high pressure spool is supplied with power, air flow within the cycle occurs, enabling the fuel to be admitted into the combustor and the subsequent initiation of combustion. Hot pressurized gas from the high pressure spool is then delivered to the low pressure spool and the free turbine spool.

Another common method for starting a turbo machine is to provide pneumatic or hydraulic power to the high pressure spool turbo compressor. For example, a high pressure fluid, such as air, may be delivered through conduits using a control valve to operate a starter turbine, which may be a gas turbine affixed to the shaft of turbo compressor spool.

U.S. patent application Ser. No. 12/115,134 describes several methods of starting such a multi-spool engine including the use of a combined motor/generator device coupled to the electrical system of a vehicle such that the vehicle power supply may be used to operate the motor/generator device for starting the gas turbine and, after the gas turbine has been started, for converting a portion of the rotational power of the high pressure spool to electrical power.

A starter device on the high pressure spool may not be able to start a multi-spool engine rapidly and efficiently and has not been contemplated for use in controlling engine performance and responsiveness.

There therefore remains a need for new methods for starting a multi-spool turbo machine, improving engine responsiveness and operating efficiently at low power levels.

### SUMMARY

These and other needs are addressed by the various embodiments and configurations of the present invention which are directed generally to an apparatus and method for one or more of starting and/or extracting power from a gas turbine engine, controlling engine responsiveness, providing a temporary power boost, providing some engine braking and modulating compressor and turbine transient performance as engine power is changed.

In one embodiment, motor/generator devices are incorporated with each of the compressor-turbine spools in an engine that has at least two turbo-compressor spools. These provide the means for both delivering a power boost to a spool for starting or during engine operation, or extracting a small amount of power during engine operation. For example, the combined motor/generator device may be coupled to the electrical system of a vehicle such that the vehicle power supply may be used to operate the motor/generator device for starting the gas turbine and, after the gas turbine has been started, for controlling a portion of the rotational power of the spools to provide a temporary power boost, provide some engine braking and control the compressor and turbine transient performance as engine power is changed.

In other embodiments, a combined motor/generator device or devices may be coupled to the electrical system, which includes an energy storage device such as a battery pack and/or a thermal energy storage devices. This energy storage system may be used to provide short bursts of energy for starting and, when needed, for a rapid power boost to the vehicle. In other configurations, a combined motor/generator device or devices may be used, in generating mode, to extract a small amount of power, thereby slowing down the mass flow through the engine. This reduction in mass flow will tend to apply a braking force on the free power turbine spool when the load device is disconnected such as would happen when the transmission clutch is engaged.

In other configurations, small motor/generator devices on several or all of the compressor/turbine spools, which are coupled to an electrical system that includes an energy storage device, such as for example, a battery pack, may be used to modify the pressure ratios of their respective spools thereby allowing control over the responsiveness of the engine to changes in, for example, ambient air temperature or density, or rapid variations in load.

In certain configurations, efficiency is also increased by the addition of a variable vane turbine nozzle between a low pressure turbo compressor spool and a free turbine spool. The variable vane turbine nozzle allows the user to have control over the level of fuel consumption enabling the user to lower the fuel consumption by the gas turbine. Such a variable vane nozzle is prior art and is described for example in U.S. Pat. No. 7,393,179 entitled “Variable Position Turbine Nozzle”.

In one configuration of the embodiment, a gas turbine engine is provided, comprising a turbo-compressor spool comprising a compressor and turbine operatively connected by a shaft, a motor/generator in mechanical communication with the shaft to cause mass flow through the compressor of the spool wherein the mass flow is comprised of at least one of air, fuel and products of combustion, a combustor, in fluid communication with the spool, to combust fuel and air and provide a hot pressurized combustion product flow through a turbine of the spool, at least one of an electrical energy storage unit to store electrical energy, a thermal storage unit to store thermal energy, an auxiliary power unit and a resistive grid to dissipate electrical energy and an electrical circuit configured to provide at least one of the following operational modes: (1) a first mode to provide, by the electrical energy storage unit, electrical energy to the motor/generator to cause mass flow through the compressor of the spool, thereby enabling combustion of fuel by the combustor; (2) a second mode to provide electrical energy to a thermal energy storage unit, the thermal energy storage unit being available to preheat at least one of the air, fuel and combustion products; (3) a third mode to provide, by the electrical energy storage unit, electrical energy to the motor/generator, the motor/generator providing energy to the compressor of the spool, whereby mass flow is increased; (4) a fourth mode to extract, by the motor/generator, energy from the compressor, thereby reducing mass flow ; and (5) a fifth mode to extract, by the motor/generator, energy from the mass flow to provide some engine braking wherein a portion of this extracted energy is transferred to at least one of the electrical energy storage unit, the thermal energy storage unit, the auxiliary power unit and a resistive dissipating grid.

In another configuration of the embodiment, a method is provided comprising providing a spool comprising a compressor and turbine operatively connected by a shaft, a motor/generator in mechanical communication with the shaft to cause mass flow through the compressor of the spool wherein the mass flow is comprised of at least one of air, fuel and products of combustion, a combustor in fluid communication with the spool, to combust fuel and air and provide a hot pressurized combustion products to a turbine of the spool, and at least one of an electrical energy storage unit to store electrical energy, a thermal storage unit to store thermal energy, an auxiliary power unit and a resistive grid to dissipate electrical energy; and performing at least one of the following sub-steps: (1) providing, by the electrical energy storage unit, electrical energy to the motor/generator to cause mass flow through the compressor of the spool, thereby enabling combustion of fuel by the combustor; (2) providing electrical energy to a thermal energy storage unit, the thermal energy storage unit preheating at least one of the air, fuel and combustion products; (3) providing, by the electrical energy storage unit, electrical energy to the motor/generator, the motor/generator providing energy to the compressor of the spool, whereby mass flow is increased; (4) extracting, by the motor/generator, energy from the compressor, thereby reducing mass flow; and (5) providing some engine braking wherein a portion of this extracted energy is transferred to at least one of an electrical energy storage unit, a thermal energy storage unit, an auxiliary power unit and a resistive dissipating grid.

In another configuration of the embodiment, a method is provided, comprising activating at least one of a motor/generator to rotate a spool, the spool comprising a compressor and turbine, determining, by a microprocessor, a value or its derivative of at least one of a turbine inlet temperature, a specific fuel consumption, and a turbine inlet pressure to determine a level of start-up performance, comparing, by the microprocessor, the determined level of start-up performance to one or more respective thresholds to determine whether the determined level of start-up performance is satisfactory, when the determined level of start-up performance is not satisfactory, adjusting, by the microprocessor, a fuel consumption rate and when the determined level of start-up performance is satisfactory, deactivating, by the microprocessor, the at least one of the motor/generator.

In another configuration of the embodiment, a method is provided comprising determining, by a microprocessor, one or more operating parameters of a spool, the spool comprising a compressor and turbine to determine a current operating point, comparing the current operating point against one or more thresholds to determine an amount of power boost to be applied and activating at least one of a motor/generator to rotate the spool.

In another configuration of the embodiment, a method is provided comprising determining, by a microprocessor, one or more operating parameters of a spool, the spool comprising a compressor and turbine to determine a current operating point, comparing the current operating point against one or more thresholds to determine an amount of braking power to be extracted and activating at least one of a motor/generator in generating mode to extract power from the spool.

In another configuration of the embodiment, a method is provided comprising determining, by a microprocessor, a first operating point of a spool on a compressor map, the spool comprising a compressor and turbine, determining, by the microprocessor, a second operating point of the spool on a turbine map, based on the results of the first two steps, determining, by the microprocessor, whether the compressor and/or turbine are approaching at least one of a surge condition, a choke condition and a temperature limit, when the compressor and/or turbine are approaching the surge condition, activating at least one of a motor/generator to add energy to the compressor and/or turbine to move the compressor and/or turbine away from the surge condition and when the compressor and/or turbine are approaching the choke condition, activating the at least one of a motor/ generator to extract energy from the compressor and/or turbine to move the compressor and/or turbine away from the choke condition, and when the turbine is approaching the temperature limit condition, activating the at least one of a motor/generator to extract energy from the compressor and/or turbine to move the turbine away from the temperature limit condition.

In another configuration of the embodiment, a method is provided comprising determining, by a microprocessor, a current ambient condition, determining, by the microprocessor, a current operating point of a spool, the spool comprising a compressor and turbine, determining, by the microprocessor, a current power requirement and/or load condition and based on the results of the first three steps, determining, by the microprocessor, an engine responsiveness requirement.

These and other advantages will be apparent from the disclosure of the invention(s) contained herein.

The above-described embodiments and configurations are neither complete nor exhaustive. As will be appreciated, other embodiments of the invention are possible utilizing, alone or in combination, one or more of the features set forth above or described in detail below.

The following definitions are used herein:

The term automatic and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term computer-readable medium as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The terms determine, calculate and compute, and variations thereof, as used herein, are used interchangeably and include any type of methodology, process, mathematical operation or technique.

Energy density as used herein is energy per unit volume (joules per cubic meter).

An energy storage system refers to any apparatus that acquires, stores and distributes mechanical, electrical or heat energy which is produced from another energy source such as a prime energy source, a regenerative braking system, a third rail and a catenary and any external source of electrical energy. Examples are a battery pack, a bank of capacitors, a pumped storage facility, a compressed air storage system, an array of a heat storage blocks, a bank of flywheels or a combination of storage systems.

An engine is a prime mover and refers to any device that uses energy to develop mechanical power, such as motion in some other machine. Examples are diesel engines, gas turbine engines, microturbines, Stirling engines and spark ignition engines

A gasifier is that portion of a gas turbine engine that produce the energy in the form of pressurized hot gasses that can then be expanded across the free power turbine to produce energy.

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

A hybrid transmission as used herein is a transmission that includes mechanical gears and linkages for transmitting power from an engine to a drive shaft as well as electrical devices such as generators and traction motors also capable of transmitting power from an engine to a drive shaft. Such a transmission may operate at different times as a purely mechanical, a purely electrical or a combination of mechanical and electrical transmission. A hybrid transmission includes the capability to generate electrical energy, for example while braking.

Jake brake or Jacobs brake describes a particular brand of engine braking system. It is used generically to refer to engine brakes or compression release engine brakes in general, especially on large vehicles or heavy equipment. An engine brake is a braking system used primarily on semi-trucks or other large vehicles that modifies engine valve operation to use engine compression to slow the vehicle. They are also known as compression release engine brakes.

A mechanical-to-electrical energy conversion device refers an apparatus that converts mechanical energy to electrical energy or electrical energy to mechanical energy. It is also referred to herein as a motor/generator. Examples include but are not limited to a synchronous alternator such as a wound rotor alternator or a permanent magnet machine, an asynchronous alternator such as an induction alternator, a DC generator, and a switched reluctance generator. A traction motor is a mechanical-to-electrical energy conversion device used primarily for propulsion. The word generator is used interchangeably with alternator herein except as specifically noted.

The term module as used herein refers to any known or later developed hardware, software, firmware, artificial intelligence, fuzzy logic, or combination of hardware and software that is capable of performing the functionality associated with that element. Also, while the disclosure is presented in terms of exemplary embodiments, it should be appreciated that individual aspects of the disclosure can be separately claimed.

A permanent magnet motor is a synchronous rotating electric machine where the stator is a multi-phase stator like that of an induction motor and the rotor has surface-mounted permanent magnets. In this respect, the permanent magnet synchronous motor is equivalent to an induction motor where the air gap magnetic field is produced by a permanent magnet. The use of a permanent magnet to generate a substantial air gap magnetic flux makes it possible to design highly efficient motors. For a common 3-phase permanent magnet synchronous motor, a standard 3-phase power stage is used. The power stage utilizes six power transistors with independent switching. The power transistors are switched in ways to allow the motor to generate power, to be free-wheeling or to act as a generator by controlling frequency.

A prime power source refers to any device that uses energy to develop mechanical or electrical power, such as motion in some other machine. Examples are diesel engines, gas turbine engines, microturbines, Stirling engines, spark ignition engines and fuel cells.

A power control apparatus refers to an electrical apparatus that regulates, modulates or modifies AC or DC electrical power. Examples are an inverter, a chopper circuit, a boost circuit, a buck circuit or a buck/boost circuit.

Power density as used herein is power per unit volume (watts per cubic meter).

A recuperator as used herein is a gas-to-gas heat exchanger dedicated to returning exhaust heat energy from a process back into the pre-combustion process to increase process efficiency. In a gas turbine thermodynamic cycle, heat energy is transferred from the turbine discharge to the combustor inlet gas stream, thereby reducing heating required by fuel to achieve a requisite firing temperature.

A regenerator is a heat exchanger that transfers heat by submerging a matrix alternately in the hot and then the cold gas streams wherein the flow on the hot side of the heat exchanger is typically exhaust gas and the flow on cold side of the heat exchanger is typically gas entering the combustion chamber.

A reheat or reheater apparatus, as used herein, is an apparatus that can burn or react an air-fuel mixture wherein the apparatus is downstream of the highest pressure turbine in a Brayton cycle gas turbine system.

Specific energy as used herein is energy per unit mass (joules per kilogram).

Specific power as used herein is power per unit mass (watts per kilogram).

Spool means a group of turbo machinery components on a common shaft. A turbo-compressor spool is a spool comprised of a compressor and a turbine connected by a shaft. A free power turbine spool is a spool comprised of a turbine and a turbine power output shaft.

A switch as used herein is an electrical component that can break an electrical circuit, interrupting the current or diverting it from one conductor to another. A switch may be directly manipulated by a human as a control signal to a system, such as a computer keyboard button, or to control power flow in a circuit, such as a light switch. Automatically operated switches can be used to control the motions of machines. Switches may be operated by process variables such as pressure, temperature, flow, current, voltage, and force, acting as sensors in a process and used to automatically control a system. A switch that is operated by another electrical circuit is called a relay. Solid-state relays control power circuits with no moving parts, instead using a semiconductor device to perform switching—often a silicon-controlled rectifier or triac. The analogue switch uses two MOSFET transistors in a transmission gate arrangement as a switch that works much like a relay, with some advantages and several limitations compared to an electromechanical relay. The power transistor(s) in a switching voltage regulator, such as a power supply unit, are used like a switch to alternately let power flow and block power from flowing. The common feature of all these usages is they refer to devices that control a binary state: they are either on or off, closed or open, connected or not connected.

A thermal energy storage (“TES”) module is a device that includes either a metallic heat storage element or a ceramic heat storage element with embedded electrically conductive wires. A thermal energy storage module is similar to a heat storage block but is typically smaller in size and energy storage capacity.

A thermal oxidizer is a type of combustor comprised of a matrix material which is typically a ceramic and a large number of channels which are typically circular in cross section. When a fuel-air mixture is passed through the thermal oxidizer, it begins to react as it flows along the channels until it is fully reacted when it exits the thermal oxidizer. A thermal oxidizer is characterized by a smooth combustion process as the flow down the channels is effectively one-dimensional fully developed flow with a marked absence of hot spots.

A thermal reactor, as used herein, is another name for a thermal oxidizer.

A turbine is any machine in which mechanical work is extracted from a moving fluid by expanding the fluid from a higher pressure to a lower pressure.

Turbine Inlet Temperature (TIT) as used herein refers to the gas temperature at the outlet of the combustor which is closely connected to the inlet of the high pressure turbine and these are generally taken to be the same temperature. Turbine Inlet Temperature can also refer to the temperature at the inlet of any turbine in the engine.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

The invention may take form in various components and arrangements of components, and in various steps and arrangements of steps. The drawings are only for purposes of illustrating the preferred embodiments and are not to be construed as limiting the invention. In the drawings, like reference numerals refer to like or analogous components throughout the several views

FIG. 1 depicts a prior art turbo machine composed of three independent spools, two nested turbo compressor spools and one free turbine spool connected to a load device.

FIG. 2 illustrates a prior art apparatus for starting the turbo machine, providing electro-mechanical motive power to the high pressure spool turbo compressor.

FIG. 3 illustrates a prior art electric motor/generator combination, connected to the highest pressure turbo compressor spool.

FIG. 4 illustrates a prior art electric motor/generator combination integrated into the high pressure spool motor/generator.

FIG. 5 illustrates integrated spool motor/generator showing generators on both low pressure and high pressure spools.

FIG. 6 illustrates an electrical system for controlling a highest pressure turbo compressor spool.

FIG. 7 illustrates an electrical system for controlling both high and low pressure turbo compressor spools.

FIG. 8 shows a high-efficiency multi-spool engine configuration with two stages of intercooling and reheat.

FIG. 9 illustrates an integrated spool motor/generator for a high-efficiency multi-spool engine configuration with two stages of intercooling and reheat.

FIG. 10 shows a flow chart illustrating an example of how motor/generators on the turbo-compressor spools can be used to start a multi-spool engine.

FIG. 11 shows a flow chart illustrating an example of how motor/generators on the turbo-compressor spools can be used to provide a power boost.

FIG. 12 shows a flow chart illustrating an example of how motor/generators on the turbo-compressor spools can be used to brake a multi-spool engine.

FIG. 13 shows typical gas turbine engine compressor maps.

FIG. 14 shows typical gas turbine engine turbine maps.

FIG. 15 shows a flow chart illustrating an example of how a motor/generator on a turbo-compressor spool can be used to avoid surge and/or choke.

FIG. 16 shows a flow chart illustrating an example of how motor/generators on the turbo-compressor spools can be used to improve engine responsiveness in a multi-spool engine.

### DETAILED DESCRIPTION

In the following examples of gas turbine engine configurations, the term “mass flow” refers to the flow of one of air, fuel and products of combustion. In many gas turbine engines, air enters the low pressure compressor and fuel is added in the combustion chamber where it is reacted. The gases exiting the combustion chamber are combustion products. In some gas turbine engine configurations, fuel and air may both be fed into the low pressure compressor but do not substantially react until they enter the combustion chamber. For example, methane and air form a mixture that typically only substantially reacts after it has entered the combustion chamber in certain gas turbine engine configurations. In the latter example, a thermal reactor may be used in place of a conventional metallic can combustion apparatus. Such a system is disclosed in U.S. Provisional Application No. 61/482,936 entitled “Thermal Reactor Combustion System for a Gas Turbine Engine” which is incorporated herein by reference.

Also, in the following discussions, a hybrid transmission is used as an example of a load on a gas turbine engine. The engines and engine control techniques disclosed herein are also applicable to an all-mechanical transmission or an all-electric transmission when the engine is used in any application, especially vehicular applications.

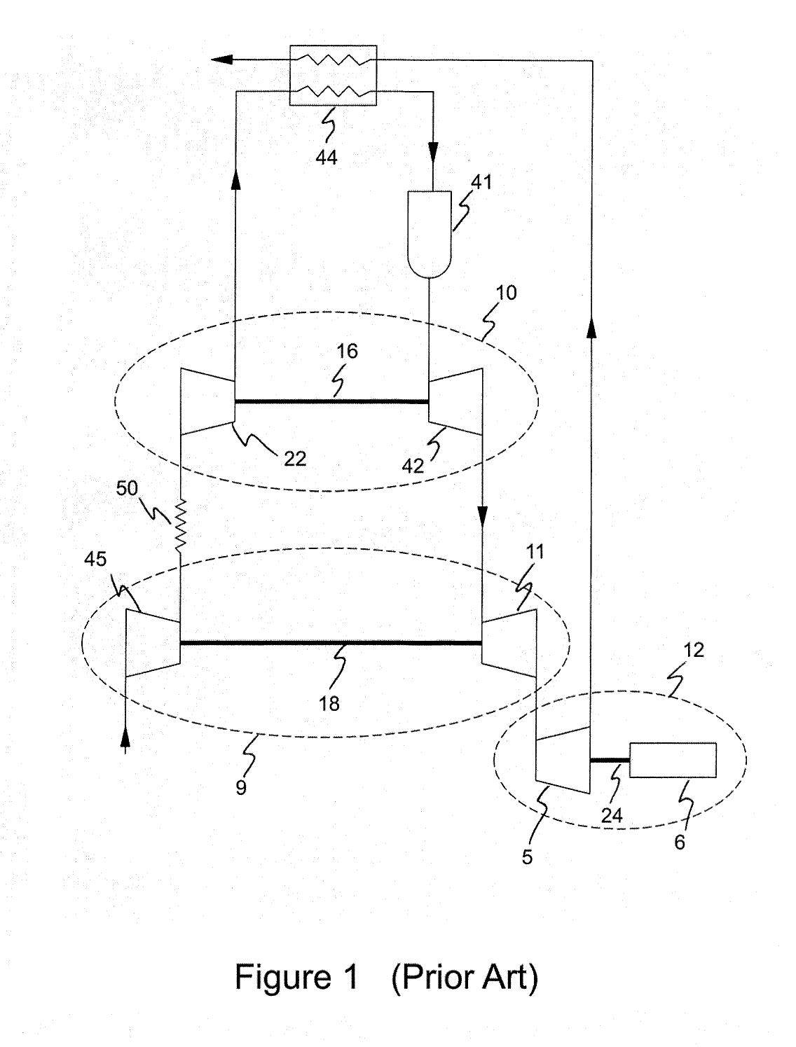

FIG. 1 illustrates a prior art turbo machine composed of three independent spools, two nested turbo-compressor spools and one free turbine spool connected to a load device. A conventional gas turbine may be composed of two or more turbo-compressor spools to achieve a progressively higher pressure ratio. A turbo machine composed of three independent rotating assemblies or spools, including a high pressure turbo-compressor spool 10, a low pressure turbo-compressor spool 9, and a free turbine spool 12 appears in FIG. 1. As seen in FIG. 1, the high pressure spool 10 is composed of a compressor 22, a turbine 42, and a shaft 16 connecting the two. The low pressure spool 9 is composed of a compressor 45, a turbine 11, and a shaft 18 connecting the two. The free turbine spool 12 is composed of a turbine 5, a load device 6, and a shaft 24 connecting the two. The load device is normally a generator or a transmission for a vehicular application. A combustor 41 is used to heat the air between the recuperator 44 and high pressure turbine 42.

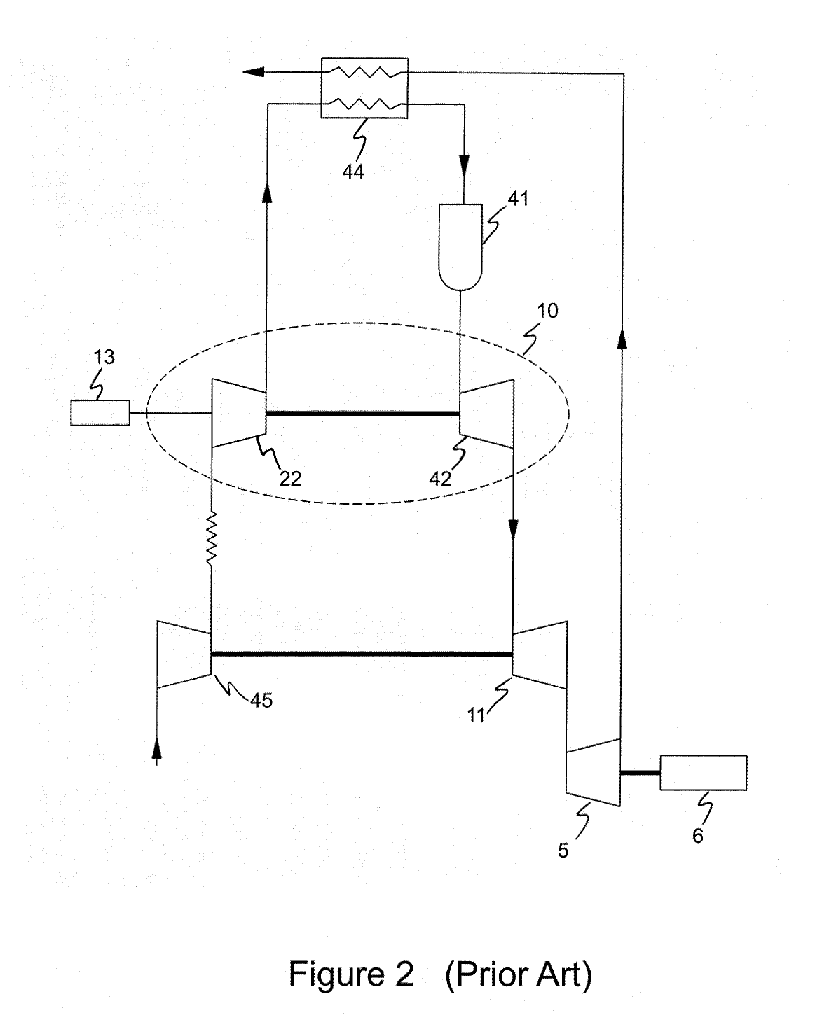

FIG. 2 illustrates a prior art apparatus for starting a turbo machine, providing electro-mechanical motive power to the high pressure spool turbo compressor. This figure illustrates a common method for starting a turbo machine by providing electro-mechanical motive power to the high pressure spool 10. A motor/clutch 13 is engaged to provide rotary power to the high pressure spool 10. Once the high pressure spool 10 is supplied with power, air flow within the cycle occurs, enabling the fuel to be admitted into the combustor and the subsequent initiation of combustion. Hot pressurized gas from the high pressure spool 10 is delivered to the low pressure spool and the free turbine spool.

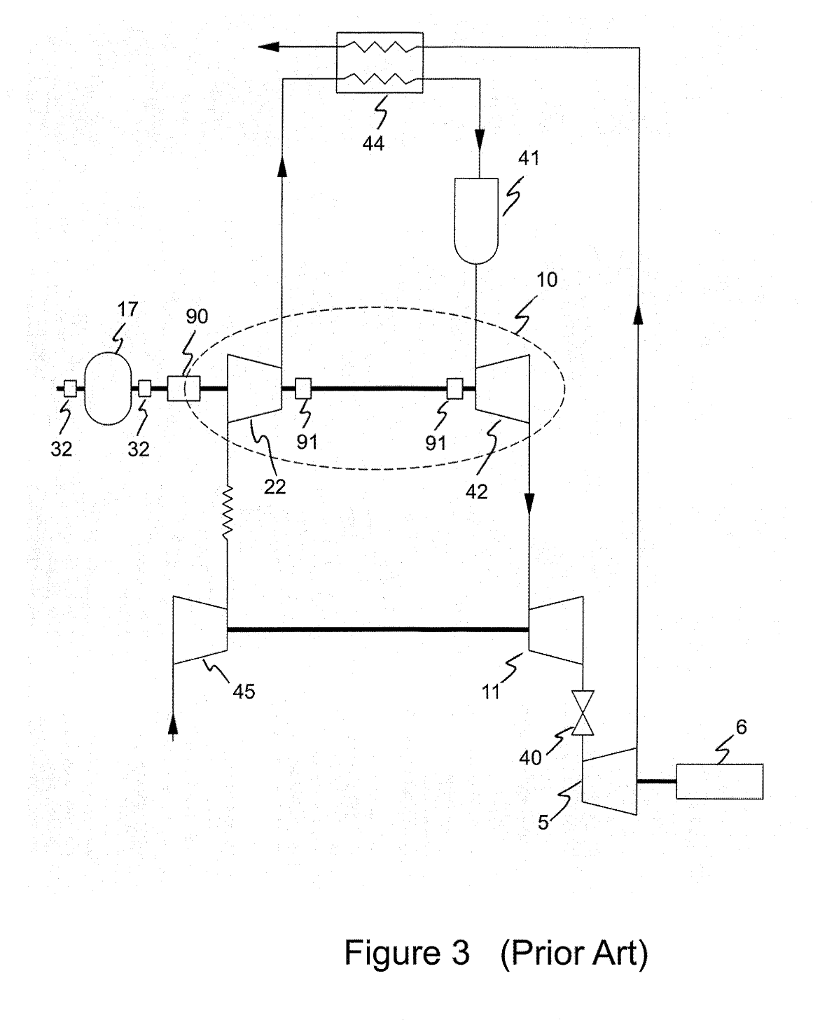

FIG. 3 illustrates a prior art electric motor/generator combination, connected to the highest pressure turbo-compressor spool. A motor/generator combination 17 provides a means for starting the gas turbine as well as the option of extracting a small amount of power (for example, less than about 10% of the power output of the engine) during engine operation. This small amount of extracted energy provides a means of controlling the speed of high pressure spool turbo-compressor 10 while the engine operates at minimum power near the idle point. The relatively small amount of electric power generated is well suited for vehicular auxiliary electric system loads, independent of drive power needed for the vehicle. Also shown in FIG. 3, is a method of power take off for a single spool starter for a gas turbine engine, which requires the coupling of motor/generator 17 at the inlet end of the compressor shaft. Single spool gas turbines, configured as a turbo-compressor generator assembly, require a mechanical coupling to connect turbo compressor 10, operating on its main bearings 91, to the generator load, operating on its bearings 32. In such an embodiment, turbo-compressor 10 and generator 17 are installed on their own bearings 91 and 32, respectively, with a coupling 90 employed to connect the two rotating machines. In certain configurations, coupling 90 may incorporate a mechanical clutch or mechanism typically used to engage and disengage the starting device. This figure was disclosed in U.S. patent application Ser. No. 12/115,134 entitled “Multi-Spool Intercooled Recuperated Gas Turbine”.

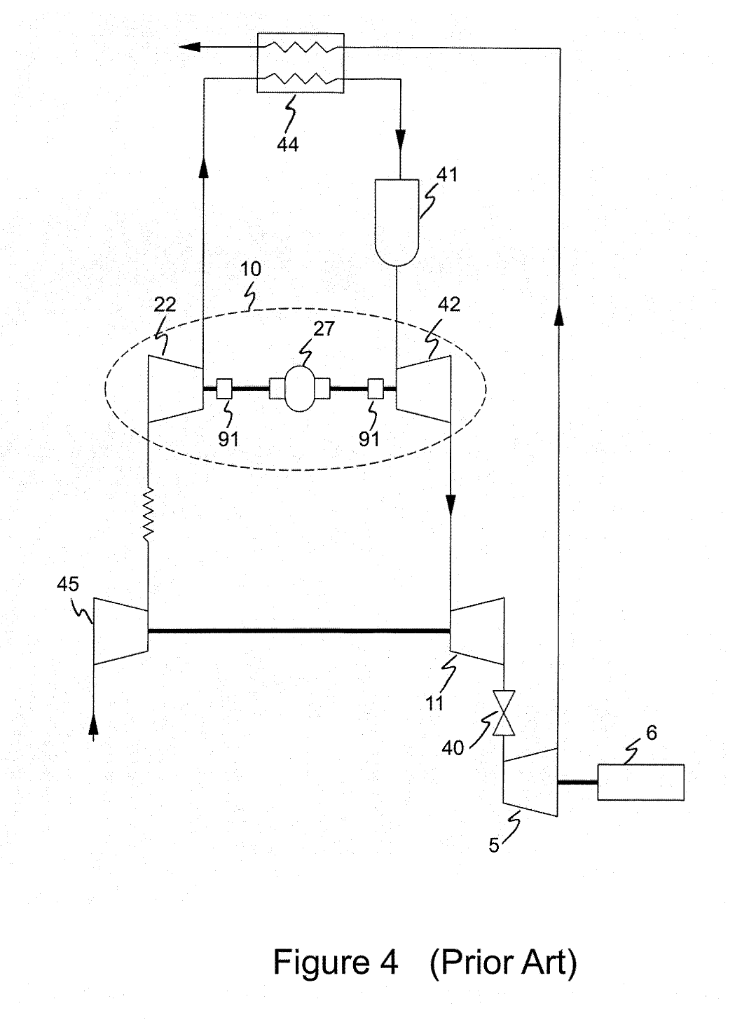

FIG. 4 illustrates a prior art electric motor/generator combination integrated into the high pressure spool. Due to the small fraction of the turbine power devoted to the load, the size of generator 27 is relatively small when compared to generators driven by gas turbines. For this reason, a compact shaft-speed generator may be installed on turbine generator spool 10 without separate bearings and couplings. For example, a samarium-cobalt type permanent magnet generator is small enough to fit within a hollow portion of the shaft, either between compressor 22 and turbine 42 or overhung from the compressor inlet. FIG. 4 illustrates a variation on the integrated high pressure spool motor/generator device, incorporating a compact motor/generator combination 27 between turbine 42 and compressor 22. The terms “generator” and “alternator” are used interchangeably herein unless specifically stated otherwise. This figure was disclosed in U.S. patent application Ser. No. 12/115,134 entitled “Multi-Spool Intercooled Recuperated Gas Turbine”.

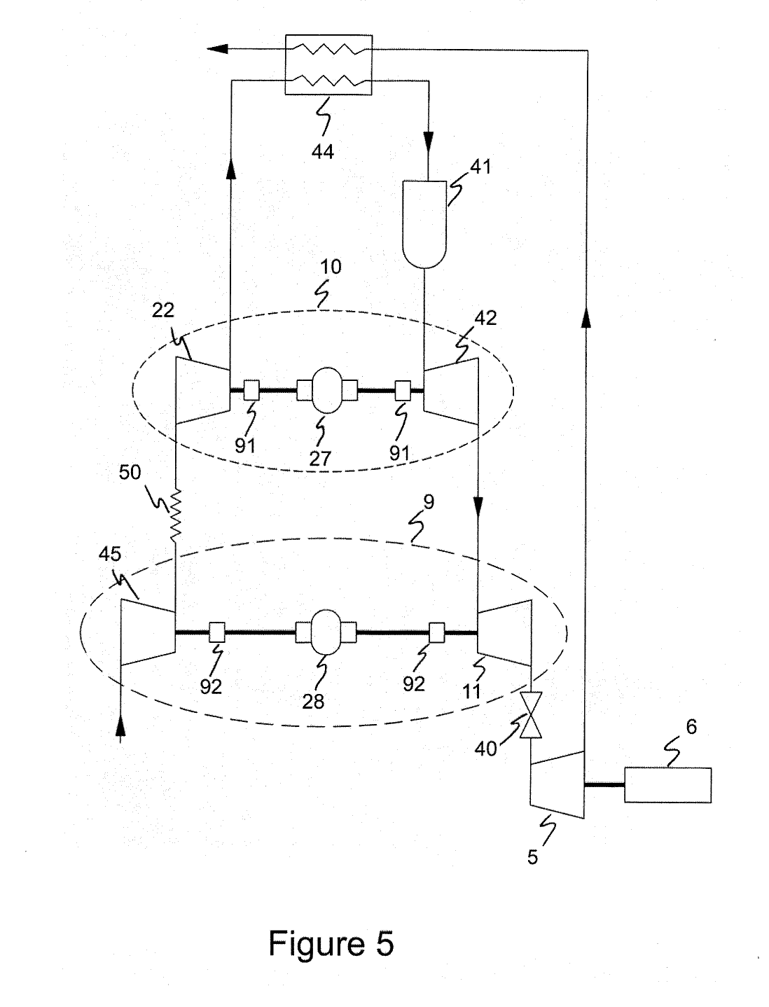

FIG. 5 illustrates integrated spool motor/generator showing generators on both low pressure and high pressure spools. FIG. 5 is similar to FIG. 4 except that a second compact shaft-speed motor/generator 28, supported by its main bearings 92, is also shown on turbine generator spool 9 also without separate bearings and couplings. As noted previously, the sizes of generators 27 and 28 are relatively small and each is capable of extracting a small amount of power (for example, each is capable of extracting about 10% or less of the power output of the engine) during engine operation. As can be appreciated, each of the generators can be as large as the generator of FIG. 4, or either generator can be smaller than the generator of FIG. 4.

It should also be noted that it is possible to include a clutch mechanism with the integrated spool motor/generators on both low pressure and high pressure spools so that, when the engine is operating at a selected power level, one of both motor/generators can be disengaged from the shafts to reduce the parasitic load of the spinning motor/generators.

When the clutch is engaged on previously idle motor/generators, there is also energy extracted from the mass flow due to the acceleration of the rotor.

An alternate configuration would be electric motor/generator combinations such as shown in FIG. 3 on both high pressure and low pressure spools. As described in FIG. 3, the externally mounted motor/generators include a clutch mechanism for disengaging the motor/generators from their respective shafts.

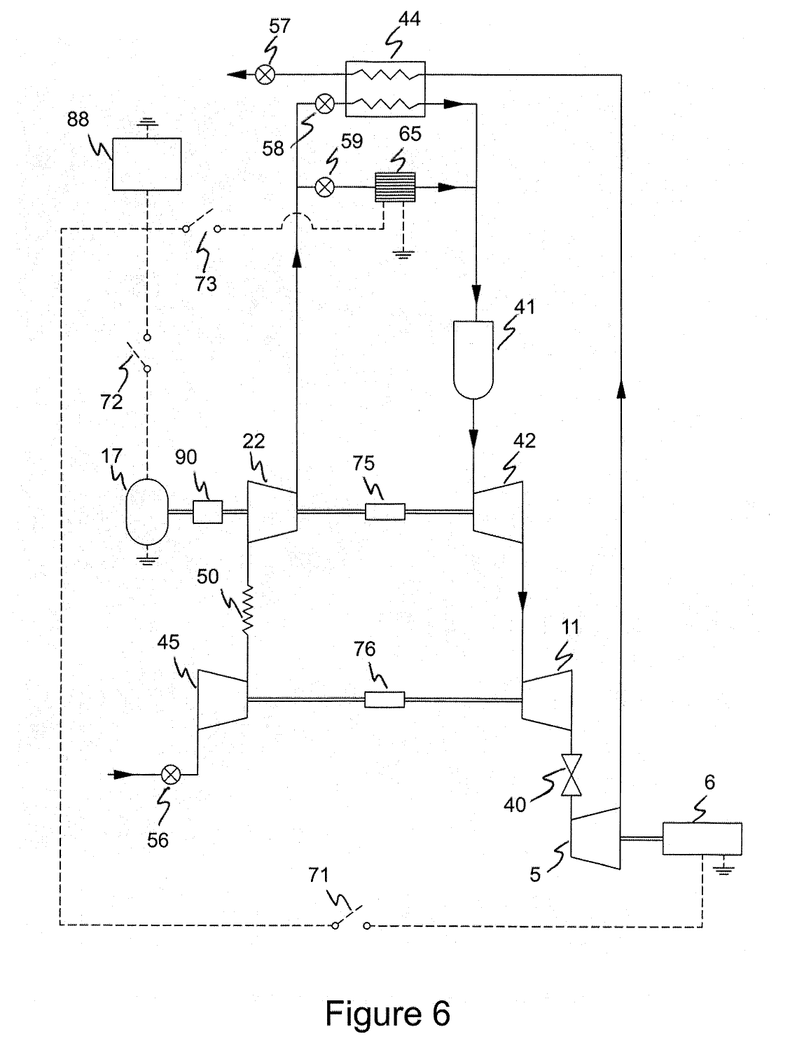

FIG. 6 illustrates an electrical system for controlling the highest pressure turbo-compressor spool. FIG. 6 shows the coupling of motor/generator 17 at the inlet end of the compressor shaft and is similar to FIG. 3 except that an electrical control circuit is also shown. The electrical circuit consists of an electrical energy storage pack 88 such, as for example, a battery or battery pack, an energy storage capacitor or bank of energy storage capacitors or a flywheel such as, for example, a homopolar generator. The electrical circuit also includes a load 6, which, in this example, includes hybrid transmission which has the capability to generate electrical energy when braking, and an optional thermal energy storage unit 65. Examples of both hybrid transmission and a thermal energy storage unit are described in U.S. patent application Ser. No. 12/777,916 entitled “Gas Turbine Energy Storage and Conversion System” which is incorporated herein by reference. The electrical circuit also includes switches 71, 72 and 73. The electrical circuit may also include an auxiliary power unit for drawing small amounts of power for lighting and heating. The electrical circuit may also include a resistive dissipating grid such as used in dynamic braking applications where electrical energy is converted into heat energy which can then be discarded in an air stream. The function of the resistive dissipating grid is to discard electrical energy when the electrical energy extracted by the motor/generator exceeds that which can be stored by the electrical energy storage pack, auxiliary power unit or the optional thermal energy storage unit (which itself typically includes a dissipative resistive grid to convert electrical energy into heat energy).

This electrical circuit of FIG. 6 provides several capabilities to the gas turbine engine. These include:

starting the engine

providing a momentary power boost when required

providing some engine braking when needed

providing over-speed protection for the free power turbine 5 when load 6 is rapidly lowered or disconnected

charging the energy storage system

controlling the responsiveness of the engine under changing load and/or ambient air conditions

restoring the compressors toward the operating line when surge or choking limits are approached

assisting the engine shut-down cycle

providing auxiliary power

For example, to start the engine, switch 72 is closed and switches 71 and 73 are opened. Energy storage unit 88 provides the power to motor/generator 17 at the inlet end of the shaft of compressor 22 with a coupling 90 employed to connect the two rotating machines Once the high pressure spool is supplied with power, mass flow within the cycle occurs, enabling the fuel to be admitted into combustor 41 and the subsequent initiation of combustion. Hot pressurized gas from the high pressure spool is delivered to the low pressure spool and the free turbine spool.

Optionally, switch 73 may also be closed and energy storage unit 88 can also provide energy to heat (via Joule heating using a resistive electrical grid) the thermal energy storage unit 65 which, in turn, can preheat the air or fuel-air flow entering combustor 41 to assist with engine starting until sufficient heat transfer is established through recuperator 44.

To provide a momentary power boost while the engine is operating, switch 72 is closed and switches 71 and 73 are opened. Energy storage unit 88 provides additional energy to motor/generator 17 which adds energy to high pressure compressor 22, increasing the mass flow throughout the system. Optionally, switch 73 may be closed and energy storage unit 88 can also provide energy to heat the thermal energy storage unit 65 which can add additional preheat energy to the air or fuel-air flow entering combustor 41, temporarily increasing combustor inlet and outlet temperatures to provide additional power for turbines 42, 11 and 5.

To provide over-speed protection for the free power turbine 5 when load 6 is rapidly lowered or disconnected, switch 72 is closed and switches 71 and 73 are opened. Motor/generator 17 then extracts a small amount of power (for example, less than about 10% of the power output of the engine) which, as described in FIG. 5, provides a means of controlling the speed of compressor 22 by reducing the mass flow through the engine which, in turn, tends to reduce the speed of free power turbine 5. As can be appreciated, when load 6 is rapidly lowered or disconnected, variable vane turbine nozzle 40 can provide additional control by further controlling the rate of flow and/or aerodynamic conditions of combustion products to the turbine 5. The power extracted by motor/generator 17 can be used, if required, to charge electrical energy storage apparatus 88.

To charge energy storage system 88 during vehicle braking (regenerative braking), switch 71 is closed and switches 72 and 73 are opened and hybrid transmission as part of load 6, in motoring mode, can be used to transfer some or all of the energy of braking to energy storage system 88. If switch 73 is closed, some of the energy of braking may also or alternately be transferred to thermal energy storage unit 65. If energy storage system 88 requires charging when the vehicle is moving but not braking, energy may be extracted from hybrid transmission as part of load 6 or from motor/generator 17.

Another means of providing engine braking (analogous to a Jake brake in a reciprocating engine) is to close switch 72 and 73 while leaving switch 71 open. Motor/generator 17 then extracts a small amount of power (for example, less than about 10% of the power output of the engine) provides a means of controlling the speed of compressor 22 by reducing the mass flow through the engine which, in turn, tends to reduce the speed of free power turbine 5. The extracted power can be used to charge energy storage battery 88 and/or heat up thermal storage unit 65, or discarded.

Motor/generator 17 may be used to exert some control over the responsiveness of the engine by adding or extracting energy from high pressure compressor 22. When a small amount of energy is added by motor/generator 17, the mass flow through the engine may be slightly increased. When a small amount of energy is extracted by motor/generator 17, the mass flow through the engine may be slightly decreased. The addition or extraction of energy may be controlled automatically to vary the responsiveness of the engine in response to changes detected in ambient air temperature and density, or in response to changing of engine load, such as when the vehicle is accelerating or braking or to optimize efficiency/fuel consumption.

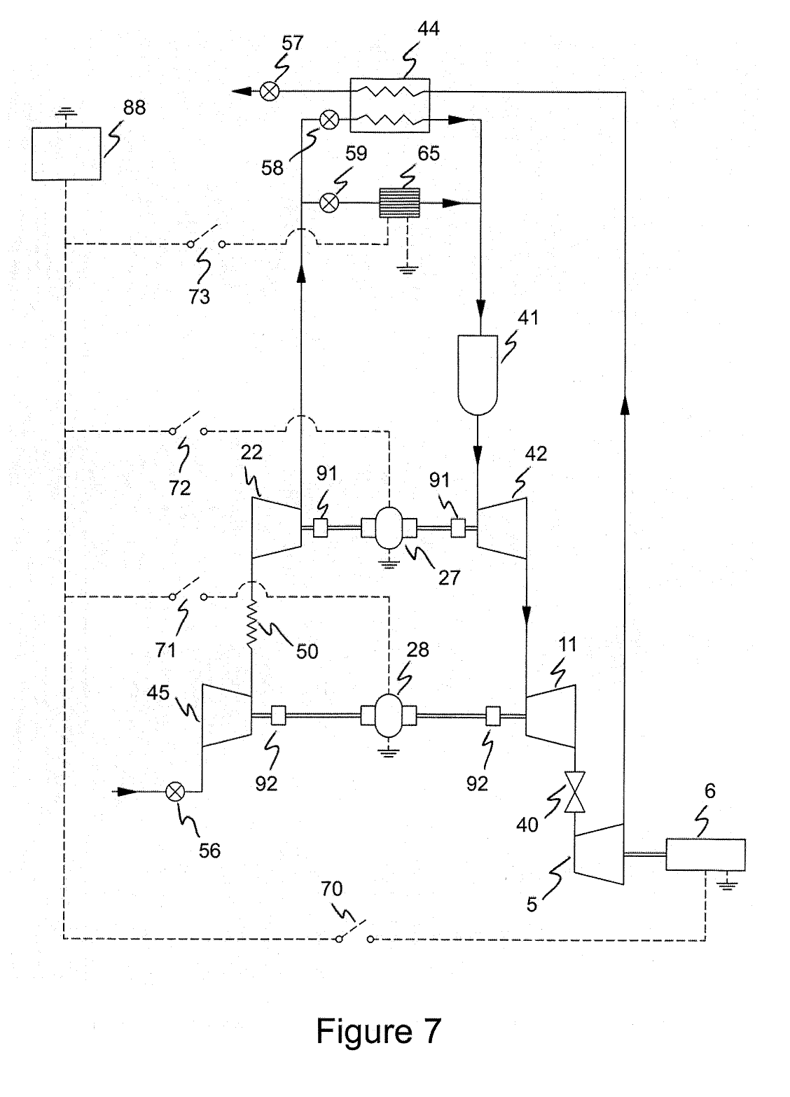

FIG. 7 illustrates an electrical system for controlling both high and low pressure turbo-compressor spools. FIG. 7 shows compact motor/generator combinations 27 and 28 between their respective turbines and compressors and is similar to FIG. 5 except that an electrical control circuit is also shown. The electrical circuit consists of an electrical energy storage pack 88; a hybrid transmission as part of load 6 which has the capability to generate electrical energy when braking; and an optional thermal energy storage unit 65. The electrical circuit also includes switches 70, 71, 72 and 73. The electrical circuit may also include an auxiliary power unit for drawing small amounts of power for lighting and heating. The electrical circuit may also include a resistive dissipating grid such as used in dynamic braking applications where electrical energy is converted into heat energy which can then be discarded in an air stream. The function of the resistive dissipating grid is to discard electrical energy when the electrical energy extracted by the motor/generator exceeds that which can be stored by the electrical energy storage pack, auxiliary power unit or the optional thermal energy storage unit (which itself typically includes a dissipative resistive grid to convert electrical energy into heat energy).

This electrical circuit provides several capabilities to the gas turbine engine shown in FIG. 7. These include:

starting the engine

providing a momentary power boost when required

providing some engine braking when needed

providing over-speed protection for the free power turbine 5 when load 6 is rapidly lowered or disconnected

charging the energy storage system

controlling the responsiveness of the engine under changing load and/or ambient air conditions

restoring the compressors and/or turbines toward the operating line when surge or choking limits are approached

assisting the engine shut-down cycle

providing auxiliary power

For example, to start the engine, switch 72 is closed and switches 70, 71 and 73 are opened. Energy storage unit 88 provides the power to motor/generator 27 between turbine 42 and compressor 22. Once the high pressure spool is supplied with power, air flow within the cycle occurs, enabling the fuel to be admitted into combustor 41 and the subsequent initiation of combustion. Hot pressurized gas from the high pressure spool is delivered to the low pressure spool and the free turbine spool. Alternately, switches 71 and 72 are closed and switches 70 and 73 are opened. Energy storage unit 88 provides power to motor/generator 27 between turbine 22 and compressor 42 and to motor/generator 28 between turbine 11 and compressor 45. Once the high pressure and low pressure spools are supplied with power, mass flow within the cycle occurs, enabling the fuel to be admitted into combustor 41 and the subsequent initiation of combustion as the desired fuel-air ratio is achieved. Hot pressurized gas from the high and low pressure spools is delivered to the free turbine spool.

Optionally, switch 73 may be closed and energy storage unit 88 can also provide power to heat the thermal energy storage unit 65 which can preheat the air or fuel-air flow entering combustor 41 until sufficient heat transfer is established through recuperator 44.

To provide a momentary power boost while the engine is operating, switches 71 and 72 are closed and switches 70 and 73 are opened. Energy storage unit 88 provides additional power to motor/generators 27 and 28 which add power to high pressure compressor 22 and low pressure compressor 45, increasing the mass flow throughout the system. Optionally, switch 73 may be closed and energy storage unit 88 can also provide power to add heat to the thermal energy storage unit 65 which can add additional preheat energy to the air or fuel-air flow entering combustor 41, temporarily increasing combustor inlet and outlet temperatures to provide additional power for turbines 42, 11 and 5.

To provide over-speed protection for the free power turbine 5 when load 6 is rapidly lowered or disconnected, switches 71 and 72 are closed and switches 70 and 73 are opened. Motor/generators 27 and 28 then extract a small amount of power which, as described in FIG. 3, provides a means of controlling the speed of compressors 22 and 45 by reducing the mass flow through the engine which, in turn, tends to reduce the speed of free power turbine 5. As can be appreciated, when load 6 is rapidly lowered or disconnected, variable vane turbine nozzle 40 can provide additional control by further controlling the mass flow to the turbine 5. The power extracted by motor/generators 27 and 28 can be used to charge electrical energy storage apparatus 88. As can be appreciated one or both of motor/generators 27 and 28 can be used to extract power to provide over-speed protection for the free power turbine 5.

To charge energy storage system 88 during vehicle braking, switch 70 is closed and switches 71, 72 and 73 are opened and hybrid transmission as part of load 6, in motoring mode, can be used to transfer some or all of the energy of braking to energy storage system 88. If switch 73 is closed, some of the energy of braking may be transferred to thermal energy storage unit 65. If energy storage system 88 requires charging when the vehicle is moving but not braking, energy may be extracted from hybrid transmission as part of load 6 or from motor/generators 27 and 28.

Another means of providing engine braking (analogous to a Jake brake in a reciprocating engine) is to close switches 71, 72 and 73 while leaving switch 70 open. Motor/generators 27 and 28 then extract small amounts of power (for example, each less than about 10% of the power output of the engine) and provide a means of controlling the speed of compressors 22 and 45 by reducing the mass flow through the engine which, in turn, tends to reduce the speed of free power turbine 5. The extracted power can be used to charge energy storage battery 88 and/or heat up thermal storage unit 65, or discarded.

Motor/generators 27 and 28 may be used to exert control over the responsiveness of the engine by adding or extracting energy from their respective compressors. When a small amount of energy is added by both motor/generators 27 and 28, the mass flow through the engine may be slightly increased. When a small amount of energy is extracted by both motor/generators 27 and 28, the mass flow through the engine may be slightly decreased.

In other situations, motor/generator 27 may add energy while motor/generator 28 may extract energy. This would tend to temporarily increase the pressure rise through compressor 22 while temporarily decreasing the pressure rise through compressor 45. This will cause a temporary redistribution of mass flow which can be used to modify the responsiveness of the engine to changes detected in ambient air temperature and density or in response to changing of engine load, such as when the vehicle is accelerating or braking. As can be appreciated, motor/generator 27 may extract energy while motor/generator 28 may add energy. This would tend to temporarily decrease the pressure rise through compressor 22 while temporarily increasing the pressure rise through compressor 45. This will cause a temporary redistribution of mass flow which can be used to modify the responsiveness of the engine in a different way from that described previously.

The addition or extraction of energy by the two motor/generators may be controlled automatically to vary the responsiveness of the engine in response to changes detected in ambient air temperature and density or in response to changing of engine load, such as when the vehicle is accelerating or braking.

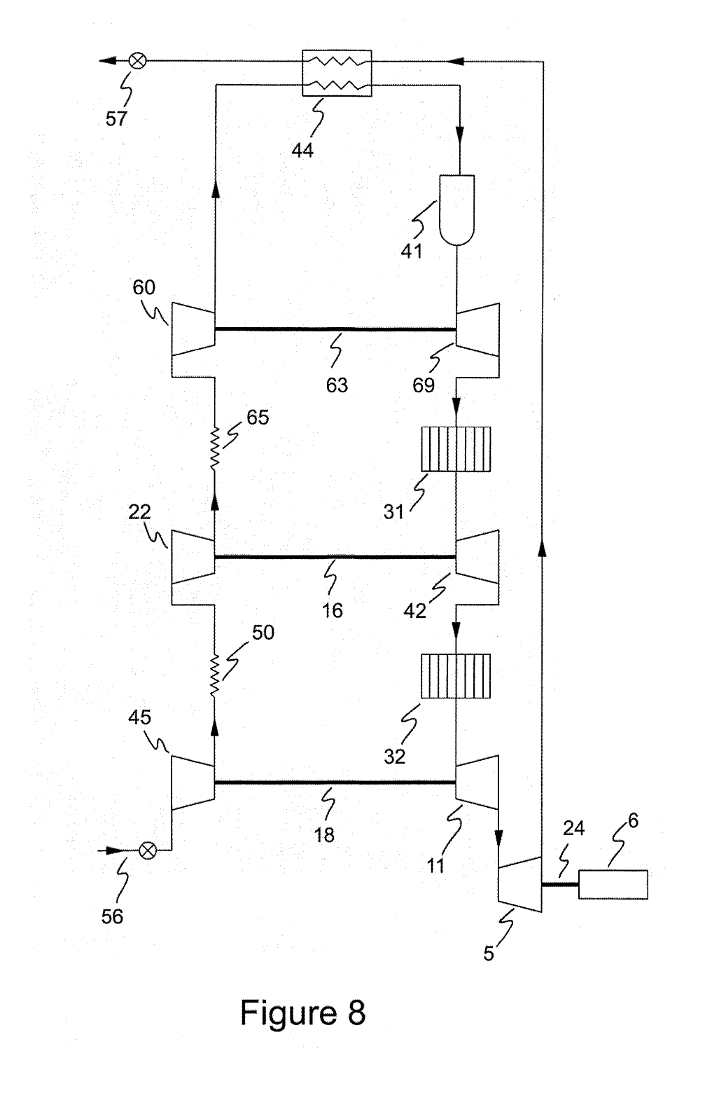

FIG. 8 shows a high-efficiency multi-spool engine configuration with two stages of intercooling and reheat. FIG. 8 shows an architecture for a gas turbine with multiple heat rejections and additions with shaft power being delivered by a free power turbine. The working fluid (typically air) is ingested at inlet 56 and fed to compressor 45. Heat is extracted by a first intercooler 50 and then delivered to compressor 22. Additional heat is extracted by a second intercooler 65 and then delivered to compressor 60. The output of compressor 60 is input into the cold side of recuperator 44 where heat from the exhaust stream is added. The working fluid is then introduced along with fuel to combustor 41 which brings the combustion products at approximately constant pressure to their maximum temperature. The combustion products are expanded through turbine 69 which powers compressor 60. The output of turbine 69 is then passed through a first thermal reactor 31 which adds and combusts additional fuel to generate additional heat at approximately constant pressure in the products. The flow then enters turbine 42 where it is expanded through turbine 42 which powers compressor 22. The output of turbine 42 is then passed through a second thermal reactor 32 which adds and combusts additional fuel at approximately constant pressure to generate additional heat in the products. The flow then enters turbine 11 where it is expanded through turbine 11 which powers compressor 45. The output of turbine 11 then enters free power turbine 5 which rotates shaft 24 which in turn delivers power to load 6. The output of free power turbine 5 is then passed through the hot side of recuperator 44 where heat is extracted and used to heat the flow that is about to enter the combustor 41. The flow from the hot side of recuperator 44 is then exhausted to the atmosphere 57. This engine concept is disclosed in U.S. Provisional Application No. 61/501,552, filed Jun. 27, 2011 entitled “Advanced Cycle Gas Turbine Engine” which is incorporated herein by reference.

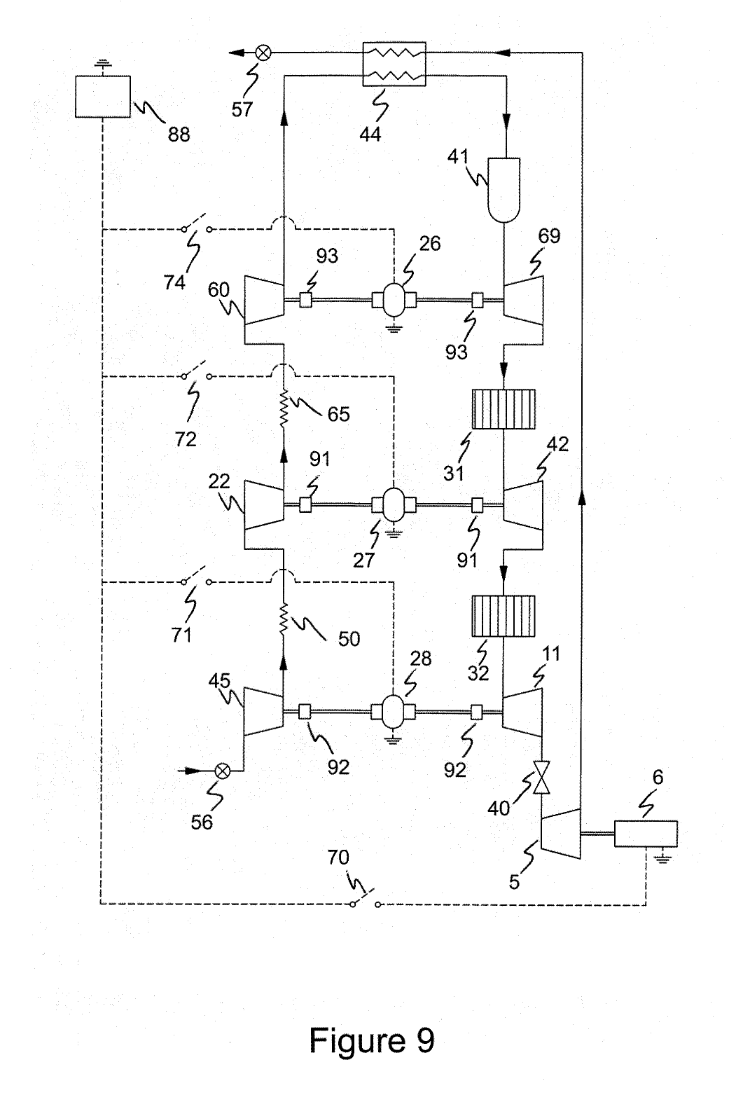

FIG. 9 illustrates integrated spool motor/generator for a high-efficiency multi-spool engine configuration with two stages of intercooling and reheat and includes an electrical system for independently controlling motor/generators. FIG. 9 shows compact motor/generator combinations 26, 27 and 28 between their respective turbines and compressors and is similar to FIG. 8 except that an electrical control circuit is also shown. The electrical circuit consists of an electrical energy storage pack 88 and, as part of load 6, a hybrid transmission which has the capability to generate electrical energy when braking. As can be appreciated, an optional thermal energy storage unit (not shown in this example) can be included such as shown as item 65 in FIG. 7. The electrical circuit also includes switches 70, 71, 72 and 74. The electrical circuit may also include an auxiliary power unit for drawing small amounts of power for lighting and heating. The electrical circuit may also include a resistive dissipating grid such as used in dynamic braking applications where electrical energy is converted into heat energy which can be discarded in an air stream. The function of the resistive dissipating grid is to discard electrical energy when the electrical energy extracted by the motor/generator exceeds that which can be stored by the electrical energy storage pack, auxiliary power unit or the optional thermal energy storage unit (which itself typically includes a dissipative resistive grid to convert electrical energy into heat energy).

This electrical circuit provides several capabilities to the gas turbine engine shown in FIG. 9. These include:

starting the engine

providing a momentary power boost when required

providing some engine braking when needed

providing over-speed protection for the free power turbine 5 when load 6 is rapidly lowered or disconnected

charging the energy storage system

controlling the responsiveness of the engine under changing load and/or ambient air conditions

restoring the compressors and/or turbines toward the operating line when surge or choking limits are approached

assisting the engine shut-down cycle

providing auxiliary power

For example, to start the engine, switch 74 is closed and switches 70, 71 and 72 are opened. Energy storage unit 88 provides the power to motor/generator 26 between turbine 69 and compressor 60. Once the high pressure spool is supplied with power, air flow within the cycle occurs, enabling the fuel to be admitted into combustor 41 and the subsequent initiation of combustion. Hot pressurized gas from the high pressure turbine 69 is re-energized by first reheater 31 and then delivered to the intermediate turbine 42. Hot pressurized gas from the intermediate turbine 42 is re-energized by second reheater 32 and then delivered to the low pressure turbine 11. The output of low pressure turbine 11 is then directed to free turbine 5.

Alternately, switches 72 and 74 are closed and switches 71 and 70 are opened. Energy storage unit 88 provides power to motor/generator 26 between turbine 69 and compressor 60 and to motor/generator 27 between turbine 22 and compressor 42. Once the high pressure and intermediate pressure spools are supplied with power, air flow within the cycle occurs, enabling the fuel to be admitted into combustor 41 and the subsequent initiation of combustion. Hot pressurized gas from the high, intermediate and low pressure spools is delivered to the free turbine spool.

If needed, switches 71, 72 and 74 are closed and switch 70 is opened. Energy storage unit 88 provides power to motor/generator 26 between turbine 69 and compressor 60, to motor/generator 27 between turbine 22 and compressor 42 and to motor/generator 28 between turbine 45 and compressor 11. Once the high pressure, intermediate pressure and low pressure spools are supplied with power, air flow within the cycle occurs, enabling the fuel to be admitted into combustor 41 and the subsequent initiation of combustion. Hot pressurized gas from the high, intermediate and low pressure spools is delivered to the free turbine spool.

Optionally, the energy storage unit 88 can also provide power to heat the thermal energy storage unit (not shown) which can preheat the air or fuel-air flow entering combustor 41 until sufficient heat transfer is established through recuperator 44.

To provide a momentary power boost while the engine is operating, switches 71, 72 and 74 are closed and switches 70 is opened. Energy storage unit 88 provides additional power to motor/generators 26, 27 and 28 which add power to high pressure compressor 60, intermediate compressor 22 and low pressure compressor 45, increasing the mass flow throughout the system.

To provide over-speed protection for the free power turbine 5 when load 6 is rapidly lowered or disconnected, switches 71, 72 and 73 are closed and switch 70 is opened. Motor/generators 26, 27 and 28 then extract a small amount of power provides a means of controlling the speed of compressors 60, 22 and 45 by reducing the mass flow through the engine which, in turn, tends to reduce the speed of free power turbine 5. As can be appreciated, when load 6 is rapidly lowered or disconnected, variable vane turbine nozzle 40 can provide additional control by further controlling the rate of flow of air to the turbine 5. The power extracted by motor/generators 26, 27 and 28 can be used to charge electrical energy storage apparatus 88. As can be appreciated, one, two or three motor/generators 26, 27 and 28 can be used to extract power to provide over-speed protection for the free power turbine 5.

To charge energy storage system 88 during vehicle braking, switch 70 is closed and switches 71, 72 and 74 are opened and hybrid transmission as part of load 6, in motoring mode, can be used to transfer some or all of the energy of braking to energy storage system 88.

Another means of providing engine braking (analogous to a Jake brake in a reciprocating engine) is to close switches 71, 72 and 74 while leaving switch 70 open. Motor/generators 26, 27 and 28 then extract small amounts of power (for example, each less than about 10% of the power output of the engine) and provide a means of controlling the speed of compressors 45, 22 and 60 by reducing the mass flow through the engine which, in turn, tends to reduce the speed of free power turbine 5. The extracted power can be used to charge energy storage battery 88 and/or heat up a thermal storage unit (not shown) or discarded.

Motor/generators 26, 27 and 28 may be used to exert control over the responsiveness of the engine by adding or extracting energy from their respective compressors. When a small amount of energy is added by one or more of the motor/generators, the mass flow through the engine may be slightly increased. When a small amount of energy is extracted by one or more of the motor/generators, the mass flow through the engine may be slightly decreased.

In other situations, one or two of the motor/generators may add energy while the third motor/generator extracts energy. This will cause a temporary redistribution of mass flow which can be used to modify the responsiveness of the engine to changes detected in ambient air temperature and density or in response to changing of engine load, such as when the vehicle is accelerating or braking. As can be appreciated, one or two of the motor/generators may extract energy while the third motor/generator adds energy. This will cause a temporary redistribution of mass flow which can be used to modify the responsiveness of the engine in a different way from that described previously.

The addition or extraction of energy by the motor/generators may be controlled automatically to vary the responsiveness of the engine in response to changes detected in ambient air temperature, density and/or humidity, or in response to changing of engine load, such as when the vehicle is accelerating or braking. The addition or subtraction of power to the spools may also lead to better turbine matching hence increased component efficiency or poor matching hence decreased component efficiency, if engine braking is desired.

Exemplary embodiments of the present invention showing the location of a variable vane turbine nozzle 40 are seen in FIGS. 3, 4, 5, 6, 7 and 9. Although the gas turbine embodiments herein may operate with a conventional fixed geometry turbine nozzle, the use of a variable vane turbine nozzle 40 is advantageous in that it enables an additional control feature to lower fuel consumption by controlling the rate of flow of air and/or the aerodynamic characteristics of the air to the turbine 5 of the free turbine spool 12. The ability to lower fuel consumption makes the present development more efficient. Such a variable vane nozzle is prior art and is described for example in U.S. Pat. No. 7,393,179 entitled “Variable Position Turbine Nozzle”.

Engine Starting

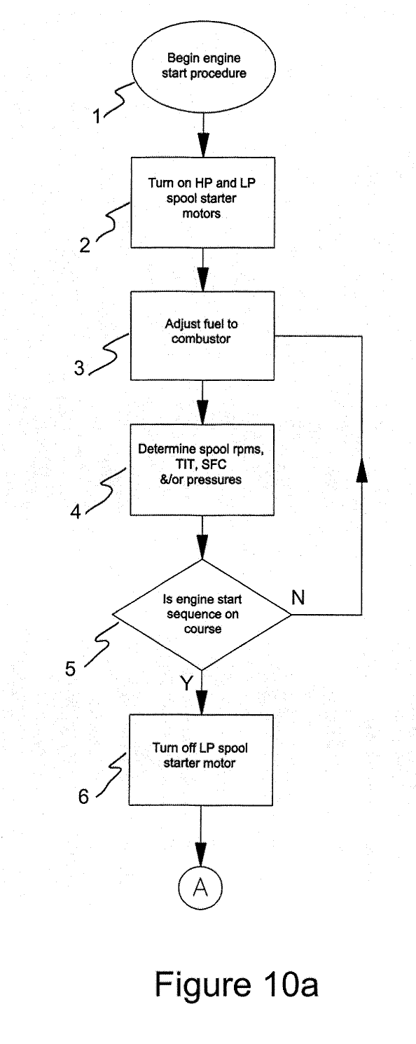

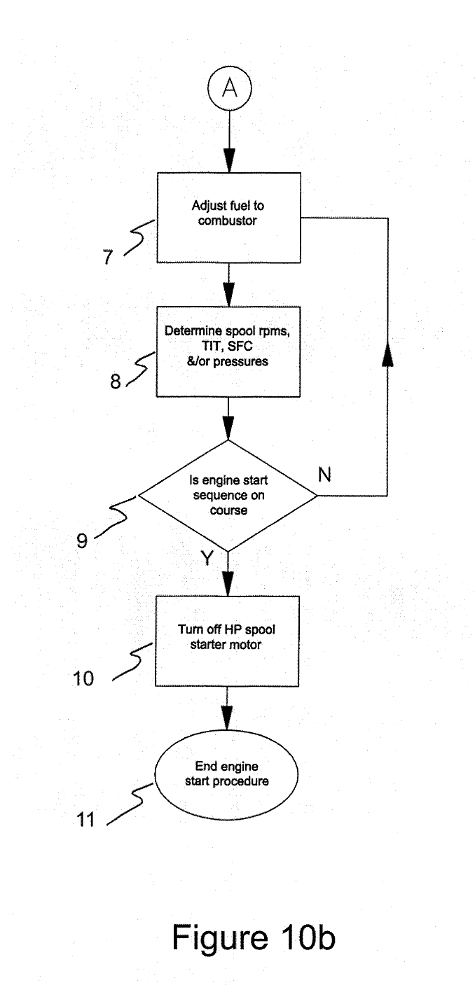

FIG. 10 shows a flow chart illustrating an example of how motor/generators on the turbo-compressor spools can be used to start a multi-spool engine. The engine start procedure begins 1 and the next step 2 is to turn on both high pressure and low pressure spool motor/generators in motoring mode (adds power to rotate the spools). The fuel to the combustor is adjusted as necessary in step 3 and then, in step 4, the value or derivative of the spool rpms, the high pressure turbine inlet temperature (“TIT”), the specific fuel consumption (“SFC”), the high pressure turbine inlet pressure and/or any other required engine other diagnostics are determined These measurements are used to determine if the engine start sequence is following its prescribed trajectory in step 5. If the engine has not achieved a certain level of start-up performance, then the sequence is returned to step 3 where fuel is further adjusted. If the engine has achieved a certain level of start-up performance, then the sequence continues to step 6 and the low pressure spool motor/generator is turned off. The fuel to the combustor is adjusted as necessary in step 7 and then, in step 8, the spool rpms, the high pressure turbine inlet temperature (“TIT”), the specific fuel consumption (“SFC”) the high pressure turbine inlet pressure and/or any required engine other diagnostics are again determined. These measurements are used to determine if the engine start sequence continues to follow its prescribed trajectory in step 9. If the engine has not achieved start-up conditions, then the sequence is returned to step 7 where fuel is further adjusted. If the engine has achieved a start-up conditions, then the sequence continues to step 10 and the high pressure spool motor/generator is turned off and the start-up sequence has successfully ended (step 11).

As can be appreciated, the amount of power from each motor/generator can be varied and the order of turning motor/generators off can be varied to achieve a consistent start-up sequence, depending on, for example, ambient conditions, engine component temperatures and the like. For example, if the engine components are warm, it may only be necessary to power-up the high pressure spool.

Power Boost

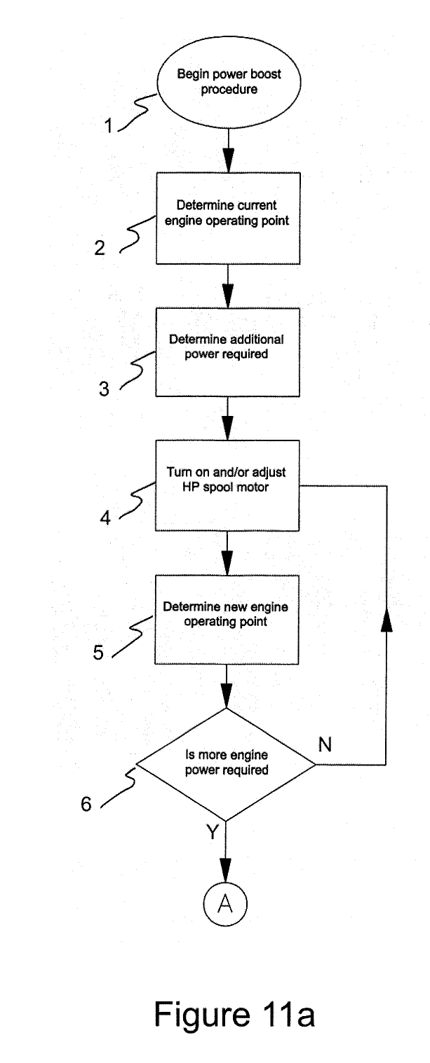

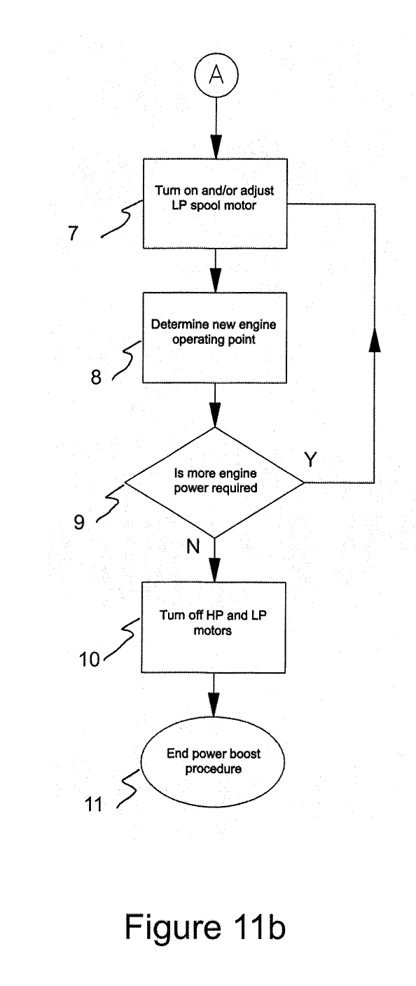

FIG. 11 shows a flow chart illustrating an example of how motor/generators on the turbo-compressor spools can be used to provide a power boost. The engine power boost procedure begins 1 and the current operating point of the engine is determined in step 2, for example measuring the spool rpms, the high pressure turbine inlet temperature (“TIT”), the specific fuel consumption (“SFC”), the high pressure turbine inlet pressure and/or any other required engine other diagnostics that may be required. The amount of power boost is determined in step 3. In step 4, the high pressure spool motor/generator is turned on in motoring mode and adjusted to provide additional power and the operating point of the engine is determined again in step 5. If additional engine boost is not required in step 6, then the procedure is returned to step 4. If additional engine boost is required in step 6, then the low pressure spool motor/generator is turned on in motoring mode and adjusted to provide additional power and the operating point of the engine is determined again in step 8. If additional engine boost is required in step 9, then the procedure is returned to step 7. If additional engine boost is not required in step 9, then high pressure and low pressure spool motor/generators are turned off (step 10) and the engine boost procedure is terminated (step 11).

If additional turbo-compressor spools are available, such as shown in FIG. 8, then they can be added to the sequence of FIG. 11. As can be appreciated, a power boost can be accomplished by powering on all the turbo-compressor spool motor/generators in motoring mode and increasing the power in each by stages as more boost power is required, as opposed to the approach described above where turbo-compressor spool motor/generators are added sequentially. Other boost power algorithms may be developed so that, as a power boost is applied, the compressors and turbines of each spool are monitored to avoid approaching a surge or choke condition or approaching a maximum temperature limit.

Engine Braking

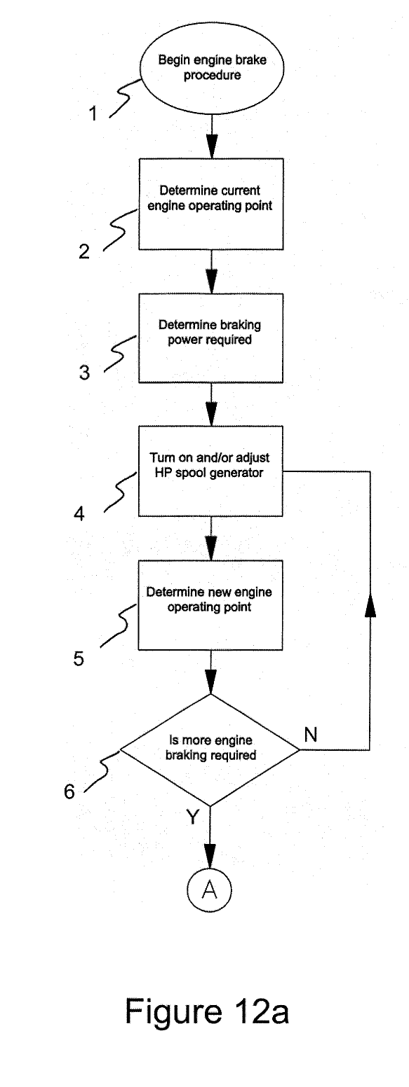

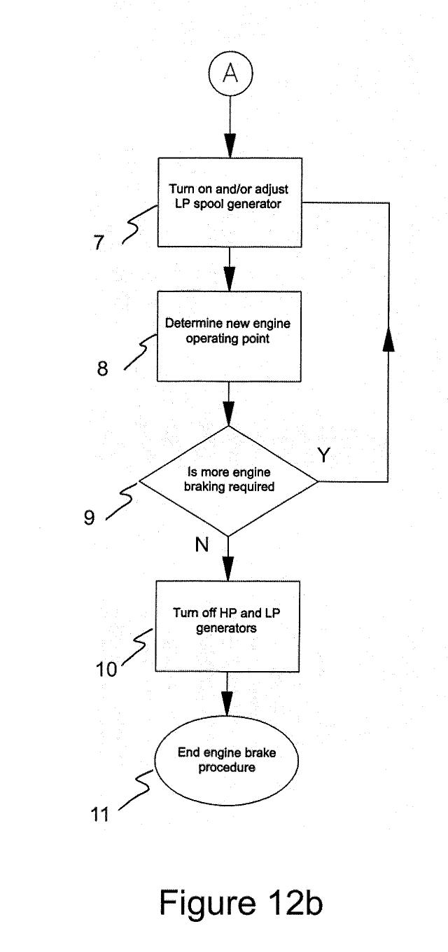

FIG. 12 shows a flow chart illustrating an example of how motor/generators on the turbo-compressor spools can be used to brake a multi-spool engine. The engine brake procedure begins 1 and the current operating point of the engine is determined in step 2, for example measuring the spool rpms, the high pressure turbine inlet temperature (“TIT”), the specific fuel consumption (“SFC”), the high pressure turbine inlet pressure and/or any other required engine other diagnostics that may be required. The amount of braking power is determined in step 3. In step 4, the high pressure spool motor/generator is turned on in generating mode and adjusted to extract power and the operating point of the engine is determined again in step 5. If additional engine braking is not required in step 6, then the procedure is returned to step 4. If additional engine braking is required in step 6, then the low pressure spool motor/generator is turned on in generating mode and adjusted to extract power and the operating point of the engine is determined again in step 8. If additional engine braking is required in step 9, then the procedure is returned to step 7. If additional engine braking is not required in step 9, then high pressure and low pressure spool motor/generators are turned off (step 10) and the engine brake procedure is terminated (step 11).

If additional turbo-compressor spools are available, such as shown in FIG. 8, then they can be added to the sequence of FIG. 12. As can be appreciated, engine braking can be accomplished by turning on all the turbo-compressor spool motor/generators in generating mode and increasing the power extracted in each by stages as more engine braking is required, as opposed to the approach described above where turbo-compressor spool motor/generators are added sequentially. Other engine braking algorithms may be developed so that, as a braking is applied, the compressors and turbines of each spool are monitored to avoid approaching a surge or choke condition.

Avoidance of Surge and Choke

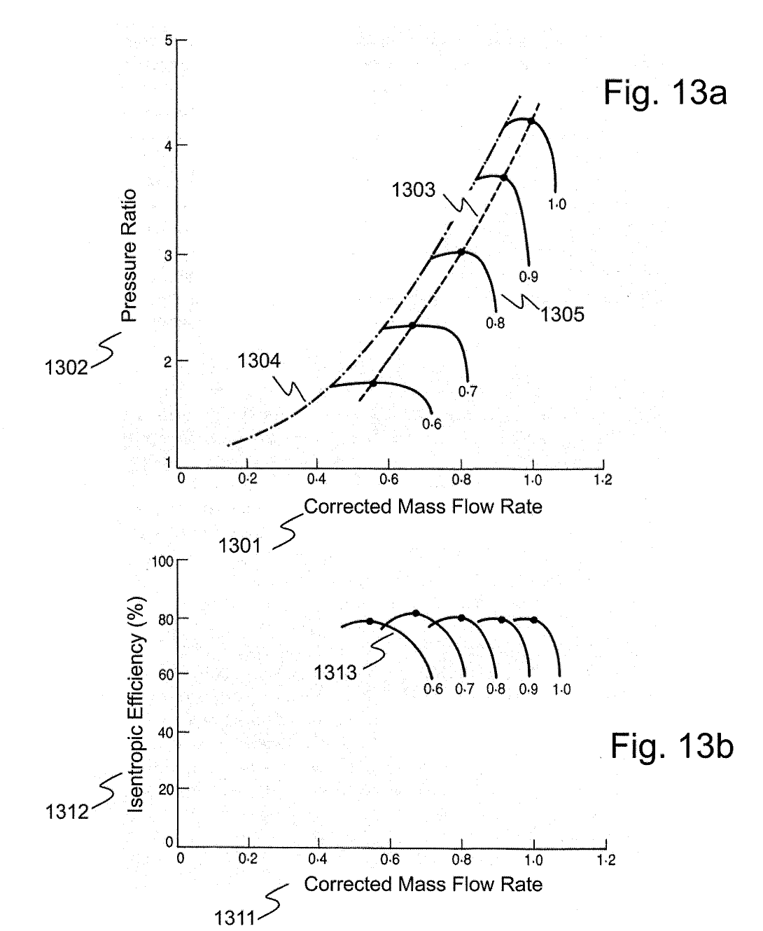

FIG. 13 shows typical gas turbine engine compressor maps. In FIG. 13a, compressor pressure ratio 1302 is plotted against corrected mass flow rate 1301. The compressor pressure ratio is the ratio of compressor outlet pressure to compressor inlet pressure. Corrected mass flow rate is actual mass flow rate times the square root of a temperature ratio divided by a pressure ratio. The temperature ratio is the inlet temperature divided by the reference temperature of 288.15 K and the pressure ratio is the inlet pressure divided by the reference pressure of 101,375 Pa. An operating line 1303 is the desired trajectory of pressure ratio for a given corrected mass flow rate for steady state operation and is typically at or near the maximum efficiency trajectory. A surge line 1304 is shown to the left of the operating line 1303 and represents the onset of surge (loss of compressor blade lift). Lines of constant rotor speed 1305 are also shown. Rotor speed is expressed as a dimensionless quantity of actual rotor speed (in rpms) divided by the square root of a temperature ratio relative to a design rotor speed value. The temperature ratio is the inlet temperature divided by the reference temperature of 288.15 K. The lines of constant dimensionless rotor speed 1305 terminate where the onset of choking begins (mass flow cannot be further increased).

In FIG. 13b, compressor isentropic efficiency 1312 is plotted against corrected mass flow rate 1311. The compressor isentropic efficiency is the ratio of isentropic temperature increase through the compressor to the actual temperature increase through the compressor. Corrected mass flow rate is as described for FIG. 13a. Lines of constant rotor speed 1313 are also shown. Rotor speed is expressed as a dimensionless quantity of actual rotor speed as described in FIG. 13a.

These maps can be used to determine compressor pressure ratio and isentropic efficiency for a given mass flow rate and these values can be used to compute compressor outlet temperature and pressure. Alternately, if compressor mass flow rate, outlet temperature and pressure are measured or otherwise known, the performance point can be plotted and used to determine if the compressor is on its desired operating trajectory or if it is approaching surge or choke conditions.

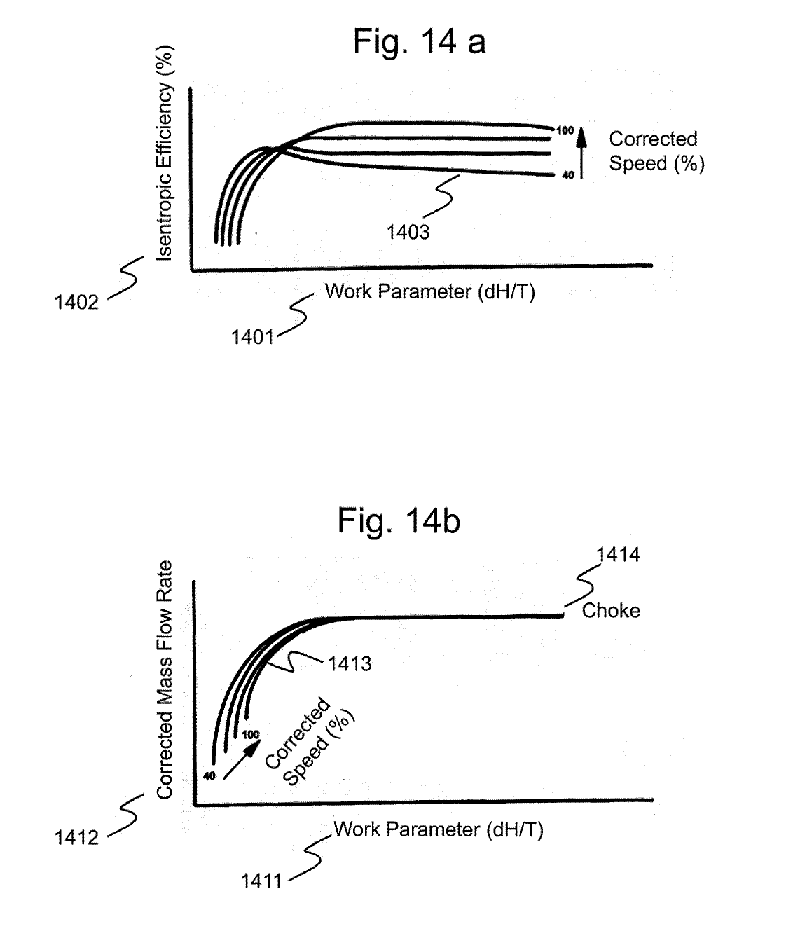

FIG. 14 shows typical gas turbine engine turbine maps. In FIG. 14a, turbine isentropic efficiency 1312 is plotted against work parameter for example. The turbine isentropic efficiency is the ratio of actual temperature drop through the turbine to the isentropic temperature drop through the turbine. The work parameter is be the change in enthalpy through the turbine divided by the turbine inlet temperature. Lines of constant rotor speed 1403 are also shown. Rotor speed is expressed as a corrected quantity of actual rotor speed (in rpms) divided by the square root of a temperature ratio relative to a design rotor speed value. The temperature ratio is the turbine inlet temperature divided by the reference temperature of 288.15 K.

In FIG. 14b, corrected mass flow rate 1412 is plotted against work parameter 1411. Corrected mass flow rate is actual mass flow rate times the square root of a temperature ratio divided by a pressure ratio. The temperature ratio is the inlet temperature divided by the reference temperature of 288.15 K and the pressure ratio is the inlet pressure divided by the reference pressure of 101,375 Pa. Lines of constant corrected rotor speed 1413 are also shown. The lines of constant corrected rotor speed all converge at the choke limit 1414.

These maps can be used to determine turbine isentropic efficiency for a given mass flow rate and work parameter and these values can be used to compute compressor outlet pressure. Alternately, if turbine mass flow rate, outlet temperature and pressure are measured or otherwise known, the performance point can be plotted and used to determine if the turbine is on its desired operating trajectory or if it is approaching choke conditions.

In addition to avoiding surge and choke conditions, the motor/generators can be used to modify engine mass flow to avoid temperature limits for the turbines downstream of the main combustor. These temperature limits are typically imposed on turbine rotors such that they can be limited to temperatures that maintain the desired material strength for safety and long life.

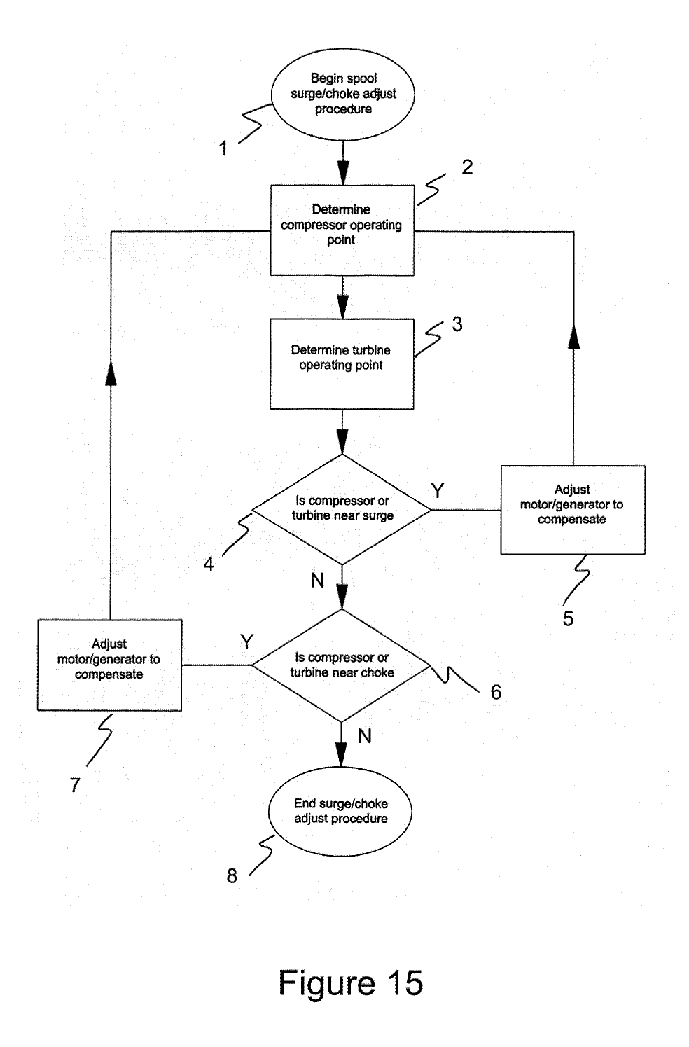

FIG. 15 shows a flow chart illustrating an example of how a motor/generator on a turbo-compressor spool can be used to avoid surge and/or choke. The avoid surge and/or choke procedure begins 1 and the next step 2 is to determine the operating point on the appropriate compressor map. This can be accomplished by measuring or otherwise determining compressor mass flow rate, outlet temperature, outlet pressure and rotor rpms. The next step 2 is to determine the operating point on the spool's corresponding turbine map. This can be accomplished by measuring or otherwise determining turbine mass flow rate, inlet temperature, work parameter and rotor rpms. In step 4, an algorithm is employed to determine if the compressor and/or turbine are approaching surge conditions. If so, then the procedure goes to step 5 where an appropriate adjustment is made by using the spool's motor/generator to add power to move the compressor and turbine away from the surge line. The procedure then returns to step 2. If the compressor and/or turbine are not approaching surge conditions then the procedure goes to step 6 where an algorithm is employed to determine if the compressor and/or turbine are approaching choke conditions. If so, then the procedure goes to step 7 where an appropriate adjustment is made by using the spool's motor/generator to extract power to move the compressor and turbine away from choke conditions. The procedure then returns to step 2. If the compressor and/or turbine are not approaching choke conditions then the procedure goes to step 8 and is ended.

This cycle of decisions can be executed continuously (for example approximately every half second) or intermittently (for example approximately every 2 seconds) or at intervals in between by a predetermined computer program or by a computer program that adapts, such as for example, a program based on neural network principles. As can be appreciated, many of the steps can be carried out in different sequences and some of the steps may be optional.

Engine Responsiveness

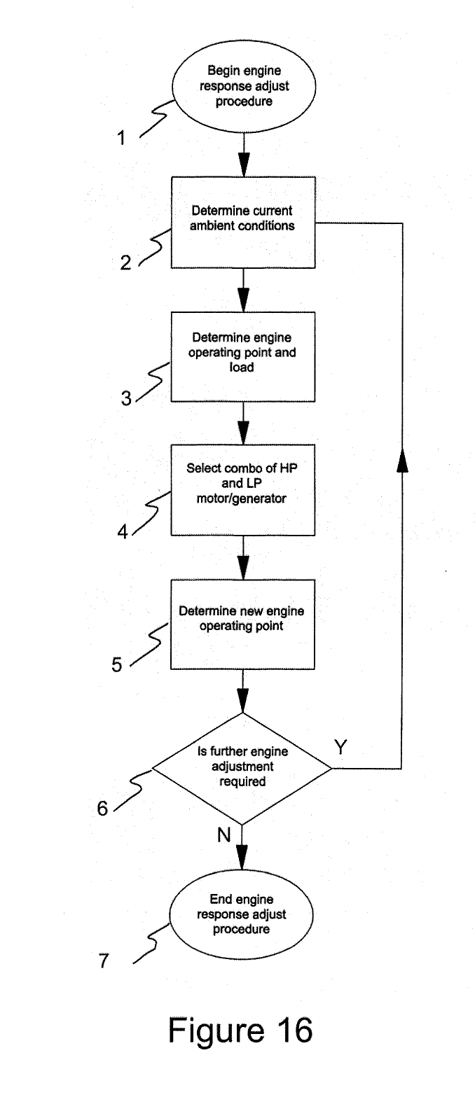

FIG. 16 shows a flow chart illustrating an example of how motor/generators on the turbo-compressor spools can be used to improve engine responsiveness in a multi-spool engine. The engine responsiveness procedure begins 1 and the next step 2 is to determine current ambient conditions such as inlet temperature, pressure and humidity. In the next step 3, the current operating point of the engine is determined, for example measuring the spool rpms, the high pressure turbine inlet temperature (“TIT”), the specific fuel consumption (“SFC”), the high pressure turbine inlet pressure and/or any other engine other diagnostics that may be required. The current engine power requirement or load condition is also determined for example by measuring or otherwise determining free power turbine shaft output power. In the next step 4, the information from steps 2 and 3 is used with an appropriate algorithm to react to an engine responsiveness requirement. Such a responsiveness requirement may be, for example, an adjustment to inlet mass flow rate to compensate for a change in ambient conditions or a change in load requirement or a combination of both. Such an adjustment may require, for example, to utilize the avoid surge and/or choke procedures described in FIG. 15 for each of the turbo-compressor spools. In the next step 5, the new operating point of the engine is determined. In step 6, if further engine adjustment is required, the procedure returns to step 2. If further engine adjustment is not required then the procedure goes to step 8 and is ended.

This cycle of decisions can be executed continuously (for example approximately every half second) or intermittently (for example approximately every 2 seconds) or at intervals in between by a predetermined computer program or by a computer program that adapts, such as for example, a program based on neural network principles. As can be appreciated, many of the steps can be carried out in different sequences and some of the steps may be optional.

Control of Engine Performance

Control of engine performance, especially for engines used in vehicle, can be accomplished by a variety of techniques. These include for example the use of a variable area nozzle or guide vanes on the inlet to the free power turbine such as disclosed in patent application Ser. No. 12/115,134 entitled “Multi-Spool Intercooled Recuperated Gas Turbine”, U.S. Pat. No. 7,393,179 entitled “Variable Position Turbine Nozzle” and shown in FIGS. 3 thru 7 and FIG. 9. As can be appreciated, the main variable in control of engine performance is control of fuel flow rates to the combustor and, if used, the re-heaters. Other forms of control include a variable area nozzles or guide vanes on the engine inlet and the use of bypass circuits on the intercooler(s), recuperator and re-heaters.

As described herein, the use of motor/generators on the turbo-compressor spools allow additional control over engine responsiveness, temporary power boost and/or assist in braking as well as help maintain the compressors and turbines close to their desired operating points.

When used to assist engine braking, the motor/generators on the turbo-compressor spools can use the extracted power to charge an energy storage system, such as for example a battery pack or a thermal energy storage device such as disclosed in U.S. patent application Ser. No. 12/777,916 entitled “Gas Turbine Energy Storage and Conversion System”.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

A number of variations and modifications of the inventions can be used. As will be appreciated, it would be possible to provide for some features of the inventions without providing others.

The present invention, in various embodiments, includes components, methods, processes, systems and/or apparatus substantially as depicted and described herein, including various embodiments, sub-combinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter

What is claimed is:

1. A gas turbine engine, comprising:
a turbo-compressor spool comprising a compressor and turbine operatively connected by a shaft;
a motor/generator in mechanical communication with the shaft to cause mass flow through the compressor of the spool wherein the mass flow is comprised of at least one of air, fuel and products of combustion;
a combustor, in fluid communication with the spool, to combust fuel and air and provide a hot pressurized combustion product flow through a turbine of the spool;
at least one of an electrical energy storage unit to store electrical energy, a thermal storage unit to store thermal energy, an auxiliary power unit and a resistive grid to dissipate electrical energy; and
an electrical circuit configured to provide at least one of the following operational modes:
a first mode to provide, by the electrical energy storage unit, electrical energy to the motor/generator to cause mass flow through the compressor of the spool, thereby enabling combustion of fuel by the combustor;
a second mode to provide electrical energy to a thermal energy storage unit, the thermal energy storage unit being available to preheat at least one of the air, fuel and combustion products;
a third mode to provide, by the electrical energy storage unit, electrical energy to the motor/generator, the motor/generator providing energy to the compressor of the spool, whereby mass flow is increased;
a fourth mode to extract, by the motor/generator, energy from the compressor, thereby reducing mass flow ; and
a fifth mode to extract, by the motor/generator, energy from the mass flow to provide some engine braking wherein a portion of this extracted energy is transferred to at least one of the electrical energy storage unit, the thermal energy storage unit, the auxiliary power unit and a resistive dissipating grid.

2. The engine of claim 1, wherein the electrical circuit is configured to provide the first mode

3. The engine of claim 2, wherein the electrical energy storage unit is connected to the motor/generator to provide energy to the turbo-compressor spool for starting.

4. The engine of claim 1, wherein the electrical circuit is configured to provide the second mode.

5. The engine of claim 4, wherein electrical energy storage unit is connected to a thermal energy storage unit to provide energy to preheat at least one of air, fuel and combustion products.

6. The engine of claim 1, wherein the electrical circuit is configured to provide the third mode.

7. The engine of claim 6, wherein the electrical energy storage unit is connected to the motor/generator to provide energy to the turbo-compressor spool for at least one of a power boost and an engine response variation.

8. The engine of claim 1, wherein the electrical circuit is configured to provide the fourth mode.

9. The engine of claim 8, wherein the turbo-compressor spool extracts energy for at least one of an engine braking force and an engine response variation.

10. The engine of claim 9, wherein a variable area turbine nozzle controls a rate of flow of combustion products to a turbine.

11. The engine of claim 1, wherein the electrical circuit is configured to provide the fifth mode.

12. The engine of claim 11, wherein the turbo-compressor spool extracts energy for at least one of an electrical energy storage unit, a thermal energy storage unit, an auxiliary power unit and a resistive dissipating grid.

13. The engine of claim 1, wherein the electrical circuit is configured to provide one or more of the second, third, fourth and fifth modes.

14. The engine of claim 1, further comprising:
a second spool comprising a second compressor and second turbine operatively connected by a second shaft; and
a second motor/generator in mechanical communication with the second shaft to cause air flow through the second compressor of the second spool, wherein the electrical circuit is configured to cause the motor/generator to one of provide electrical energy to and extract electrical energy from the compressor and the second motor/generator to the other of provide electrical energy to and extract electrical energy from the second compressor.

15. The engine of claim 1, further comprising:
a second spool comprising a second compressor and second turbine operatively connected by a second shaft; and
first and second reheaters in fluid communication with the spool and the second spool, respectively.

16. A method, comprising:
(a) providing a spool comprising a compressor and turbine operatively connected by a shaft, a motor/generator in mechanical communication with the shaft to cause mass flow through the compressor of the spool wherein the mass flow is comprised of at least one of air, fuel and products of combustion, a combustor in fluid communication with the spool, to combust fuel and air and provide a hot pressurized combustion products to a turbine of the spool, and at least one of an electrical energy storage unit to store electrical energy, a thermal storage unit to store thermal energy, an auxiliary power unit and a resistive grid to dissipate electrical energy; and
(b) performing at least one of the following sub-steps:
(B1) providing, by the electrical energy storage unit, electrical energy to the motor/generator to cause mass flow through the compressor of the spool, thereby enabling combustion of fuel by the combustor;
(B2) providing electrical energy to a thermal energy storage unit, the thermal energy storage unit preheating at least one of the air, fuel and combustion products;
(B3) providing, by the electrical energy storage unit, electrical energy to the motor/generator, the motor/generator providing energy to the compressor of the spool, whereby mass flow is increased;
(B4) extracting, by the motor/generator, energy from the compressor, thereby reducing mass flow; and
(B5) providing some engine braking wherein a portion of this extracted energy is transferred to at least one of an electrical energy storage unit, a thermal energy storage unit, an auxiliary power unit and a resistive dissipating grid.

17. The method of claim 16, wherein step (B1) is performed.

18. The method of claim 17, wherein the electrical energy storage unit is connected to the motor/generator to provide energy to the turbo-compressor spool for starting.

19. The method of claim 16, wherein step (B2) is performed.

20. The method of claim 19, wherein electrical energy storage unit is connected to a thermal energy storage unit to provide energy to preheat at least one of air, fuel and combustion products.

21. The method of claim 16, wherein step (B3) is performed.

22. The method of claim 21, wherein the electrical energy storage unit is connected to the motor/generator to provide energy to the turbo-compressor spool for at least one of a power boost and an engine response variation.

23. The method of claim 16, wherein step (B4) is performed.

24. The method of claim 23, wherein the turbo-compressor spool extracts energy for at least one of an engine braking force and an engine response variation.

25. The method of claim 23, wherein a variable area turbine nozzle controls a rate of flow of combustion products to a turbine.

26. The method of claim 16, wherein step (B5) is performed.

27. The method of claim 26, wherein the turbo-compressor spool extracts energy for at least one of an electrical energy storage unit, a thermal energy storage unit, an auxiliary power unit and a resistive dissipating grid.

28. The method of claim 16, wherein one or more of steps (B2), (B3), (B4), and (B5) is performed.

29. The method of claim 16, further comprising the step:
(c) providing a second spool comprising a second compressor and second turbine operatively connected by a second shaft and a second motor/generator in mechanical communication with the second shaft to cause air flow through the second compressor of the second spool, wherein the electrical circuit is configured to cause the motor/generator to one of provide electrical energy to and extract electrical energy from the compressor and the second motor/generator to the other of provide electrical energy to and extract electrical energy from the second compressor.

30. The method of claim 16, further comprising the step:
(c) providing a second spool comprising a second compressor and second turbine operatively connected by a second shaft and first and second reheaters in fluid communication with the spool and the second spool, respectively.

31. A method, comprising:
(a) activating at least one of a motor/generator to rotate a spool, the spool comprising a compressor and turbine;
(b) determining, by a microprocessor, a value or its derivative of at least one of a turbine inlet temperature, a specific fuel consumption, and a turbine inlet pressure to determine a level of start-up performance;
(c) comparing, by the microprocessor, the determined level of start-up performance to one or more respective thresholds to determine whether the determined level of start-up performance is satisfactory;
(d) when the determined level of start-up performance is not satisfactory, adjusting, by the microprocessor, a fuel consumption rate; and
(e) when the determined level of start-up performance is satisfactory, deactivating, by the microprocessor, the at least one of the motor/generator.

32. The method of claim 31, wherein the comparing step comprises comparing each of value or its derivative of the turbine inlet temperature, a specific fuel consumption, and a turbine inlet pressure to a respective threshold and wherein the determined level of start-up performance is not satisfactory when one or more of the value or its derivative of the turbine inlet temperature, specific fuel consumption, and turbine inlet pressure is less than the respective threshold and is satisfactory when each of the one or more of the value or its derivative of the turbine inlet temperature, specific fuel consumption, and turbine inlet pressure is more than the respective threshold.

33. The method of claim 31, wherein the determined level of start-up performance is satisfactory, wherein the spool comprises higher and lower pressure spools, each comprising a corresponding at least one of a motor/generator, wherein the at least one of a motor/generator corresponding to the lower pressure spool is deactivated in step (e), and further comprising:
(f) thereafter repeating step (b) to provide a second level of start-up performance;
(g) comparing, by the microprocessor, the second level of start-up performance to one or more respective thresholds to determine whether the second level of start-up performance is satisfactory;
(d) when the second level of start-up performance is not satisfactory, adjusting, by the microprocessor, a fuel consumption rate; and
(e) when the determined level of start-up performance is satisfactory, deactivating, by the microprocessor, the at least one of the motor/generator corresponding to the higher pressure spool.

34. A non-transitory computer readable medium operable, when executed by the microprocessor, to perform the steps of claim 31.

35. A microprocessor configured to perform the steps of claim 31.

36. A method, comprising:
(a) determining, by a microprocessor, one or more operating parameters of a spool, the spool comprising a compressor and turbine to determine a current operating point;
(b) comparing the current operating point against one or more thresholds to determine an amount of power boost to be applied; and
(c) activating at least one of a motor/generator to rotate the spool.

37. The method of claim 36, wherein power boost is required when one or more of a value or its derivative of revolutions per minute of the spool, a turbine inlet temperature, a specific fuel consumption, and a turbine inlet pressure is less than a respective threshold and no power boost is required when one or more of a value or its derivative of revolutions per minute of the spool, a turbine inlet temperature, a specific fuel consumption, and a turbine inlet pressure is more than the respective threshold.

38. The method of claim 36, wherein the spool comprises higher and lower pressure spools, each comprising a corresponding at least one of a motor/generator, wherein the at least one of a motor/generator corresponding to the higher pressure spool is activated in step (c), and further comprising:
(d) thereafter repeating steps (a) and (b) to determine that additional power boost is required; and
(e) activating, by the microprocessor, the at least one of the motor/generator corresponding to the lower pressure spool.

39. A non-transitory computer readable medium operable, when executed by the microprocessor, to perform the steps of claim 36.

40. A microprocessor configured to perform the steps of claim 36.

41. A method, comprising:
(a) determining, by a microprocessor, one or more operating parameters of a spool, the spool comprising a compressor and turbine to determine a current operating point;
(b) comparing the current operating point against one or more thresholds to determine an amount of braking power to be extracted; and
(c) activating at least one of a motor/generator in generating mode to extract power from the spool.

42. The method of claim 41, wherein braking power extraction is required when one or more of a value or its derivative of revolutions per minute of the spool, a turbine inlet temperature, a specific fuel consumption, and a turbine inlet pressure is more than a respective threshold and no braking power extraction is required when the value or its derivative of revolutions per minute of the spool, a turbine inlet temperature, a specific fuel consumption, and a turbine inlet pressure is less than the respective threshold.

43. The method of claim 41, wherein the spool comprises higher and lower pressure spools, each comprising a corresponding at least one of a motor/generator, wherein the at least one of a motor/generator corresponding to the higher pressure spool is activated in step (c), and further comprising:
(d) thereafter repeating steps (a) and (b) to determine that additional braking power extraction is required; and
(e) activating, by the microprocessor, the at least one of the motor/generator corresponding to the lower pressure spool in generating mode to extract power from the lower pressure spool.

44. A non-transitory computer readable medium operable, when executed by the microprocessor, to perform the steps of claim 41.

45. A microprocessor configured to perform the steps of claim 41.

46. A method, comprising:
(a) determining, by a microprocessor, a first operating point of a spool on a compressor map, the spool comprising a compressor and turbine;
(b) determining, by the microprocessor, a second operating point of the spool on a turbine map;
(c) based on the results of steps (a) and (b), determining, by the microprocessor, whether the compressor and/or turbine are approaching at least one of a surge condition, a choke condition and a temperature limit;
(d) when the compressor and/or turbine are approaching the surge condition, activating at least one of a motor/generator to add energy to the compressor and/or turbine to move the compressor and/or turbine away from the surge condition; and
(e) when the compressor and/or turbine are approaching the choke condition, activating the at least one of a motor/ generator to extract energy from the compressor and/or turbine to move the compressor and/or turbine away from the choke condition; and
(f) when the turbine is approaching the temperature limit condition, activating the at least one of a motor/generator to extract energy from the compressor and/or turbine to move the turbine away from the temperature limit condition

47. The method of claim 46, wherein the first operating point is determined by determining one or more of compressor mass flow rate, compressor inlet temperature, compressor inlet pressure, and compressor rotor revolutions per minute and wherein the second operating point is determined by determining one or more of turbine mass flow rate, turbine inlet temperature, turbine work parameter, and turbine rotor revolutions per minute.

48. A non-transitory computer readable medium operable, when executed by the microprocessor, to perform the steps of claim 46.

49. A microprocessor configured to perform the steps of claim 46.

50. A method, comprising:
(a) determining, by a microprocessor, a current ambient condition;
(b) determining, by the microprocessor, a current operating point of a spool, the spool comprising a compressor and turbine;
(c) determining, by the microprocessor, a current power requirement and/or load condition; and
(d) based on the results of step (a)-(c), determining, by the microprocessor, an engine responsiveness requirement.

51. The method of claim 50, wherein the current ambient condition is one or more of inlet temperature, inlet pressure, and inlet humidity, wherein the current operating point of the spool is determined by measuring one or more of spool revolutions per minute, a turbine inlet temperature, a specific fuel consumption, and a turbine inlet pressure, and wherein a current power requirement and/or load condition is determined by measuring a power turbine shaft output power.

52. The method of claim 50, wherein an engine responsiveness requirement is not satisfactory and further comprising:
(e) adjusting, by the microprocessor, one or more of an inlet mass flow rate and inlet humidity to compensate for a change in the ambient condition and a change in the power requirement and/or load condition.

53. A non-transitory computer readable medium operable, when executed by the microprocessor, to perform the steps of claim 50.

54. A microprocessor configured to perform the steps of claim 50.
